(19) United States
(12) Patent Application Publication
(10) Pub. No.: US 2014/0040007 A1
(43) Pub. Date: Feb. 6, 2014

(54) PROMOTION CREATOR AND MANAGER

(71) Applicants: Donald H. RELYEA, JR., Dallas, TX (US); Venket S. KANDANALA, Highland Village, TX (US); Nisheeth GUPTA, Irving, TX (US); Nicky P. JOSHI, Flower Mound, TX (US)

(72) Inventors: Donald H. RELYEA, JR., Dallas, TX (US); Venket S. KANDANALA, Highland Village, TX (US); Nisheeth GUPTA, Irving, TX (US); Nicky P. JOSHI, Flower Mound, TX (US)

(73) Assignee: VERIZON PATENT AND LICENSING INC., Basking Ridge, NJ (US)

(21) Appl. No.: 13/563,287

(22) Filed: Jul. 31, 2012

(51) Int. Cl. G06Q 30/02

(52) U.S. Cl. CPC G06Q 30/0242
USPC 705/14.41; 705/14.61; 705/14.57

(57) ABSTRACT

A device may receive information that identifies a design item associated with a promotion, where the design item relates to an appearance of the promotion, may receive information that identifies a promotion characteristic associated with the promotion, where the promotion characteristic identifies at least one of a product or a service associated with the promotion, may receive distribution information associated with the promotion, where the distribution information identifies a customer device to which the promotion is to be sent, and may receive scheduling information associated with the promotion, where the scheduling information identifies a time period during which the promotion is active. The device may also provide the promotion to the customer device based on the design item, the promotion characteristic, the distribution information, and the scheduling information.

### BACKGROUND

A merchant may offer a promotion in order to attract customers. For example, a merchant may offer a discount for products or services. When creating or managing a promotion, a merchant may have to make decisions about many different details of the promotion in order to achieve the best possible outcome from the promotion.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a diagram of example functional components of one or more devices of FIG. 2;

FIG. 5 is a diagram of an example process for creating a promotion according to an implementation described herein;

FIGS. 6-11 are diagrams of example user interfaces for creating a promotion;

FIG. 12 is a diagram of an example process for activating a promotion according to an implementation described herein;

FIGS. 13-15 are diagrams of example user interfaces for activating a promotion;

FIG. 16 is a diagram of an example process for providing a recommendation associated with a promotion according to an implementation described herein;

FIG. 17 is a diagram of an example process for creating a promotion report according to an implementation described herein; and

FIG. 18 is a diagram of an example user interface for displaying a promotion report.

### DETAILED DESCRIPTION OF PREFERRED EMBODIMENTS

The following detailed description of example embodiments refers to the accompanying drawings. The same reference numbers in different drawings may identify the same or similar elements.

As used herein, a “promotion” may refer to an advertisement, a discount, a giveaway, an offer, a coupon, a reward, etc., associated with products and/or services of a merchant. “Activating” a promotion may refer to determining a target market (e.g., target customers) for a promotion, and/or determining a time period associated with a promotion (e.g., a time period during which a promotion will be offered, provided, and/or delivered to customers). As used herein, “customer” may refer generally to a user, or may refer to an existing customer and/or a new customer. A new customer may refer to a person that has not previously purchased a product and/or service from a particular merchant.

A merchant may create and activate a promotion in order to attract customers and/or achieve business goals. However, it may be difficult to create, manage, and analyze a promotion or a group of promotions. Implementations described herein may allow merchants to easily create, activate, manage, and analyze a promotion. Furthermore, implementations described herein may provide recommendations associated with a promotion in order to help a merchant attract customers and/or achieve business goals.

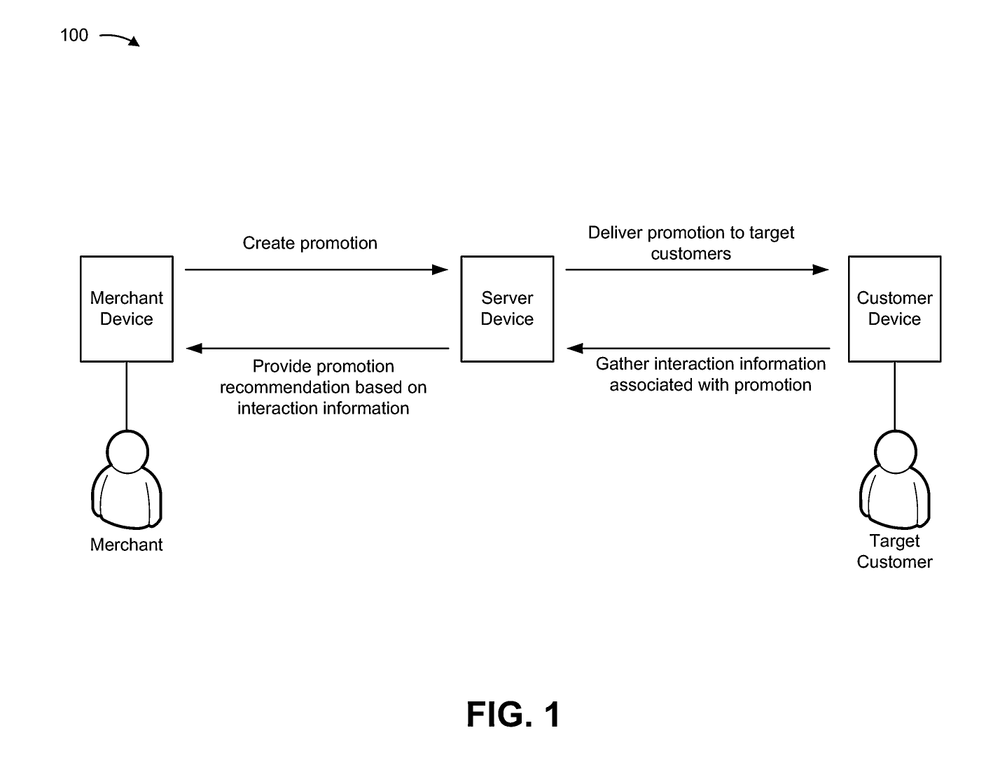

FIG. 1 is a diagram of an overview 100 of an example implementation described herein. As shown in FIG. 1, the example implementation may include a merchant device, a server device, and a customer device. For example, the merchant device may be a tablet computer, the server device may be a server, and the customer device may be a smart phone.

A merchant may use the merchant device to create a promotion, associate a target customer with the promotion, and schedule a date to activate the promotion. The promotion, the target customer, and the scheduled date may be transmitted to the server device. The server device may deliver the promotion to a customer device associated with the target customer on the scheduled date.

The target customer may interact with the promotion. For example, the target customer may purchase products and/or services advertised in the promotion, may share the promotion with another customer, may forward the promotion to another customer, and/or may interact with the promotion using a social media application or web site. When the customer interacts with the promotion using the customer device, the customer device may send interaction information to the server device. The server device may aggregate interaction information from multiple customer interactions, and may analyze the aggregated interaction information (e.g., to determine the effectiveness of a promotion). The server device may provide a promotion recommendation to the merchant device based on the aggregated interaction information.

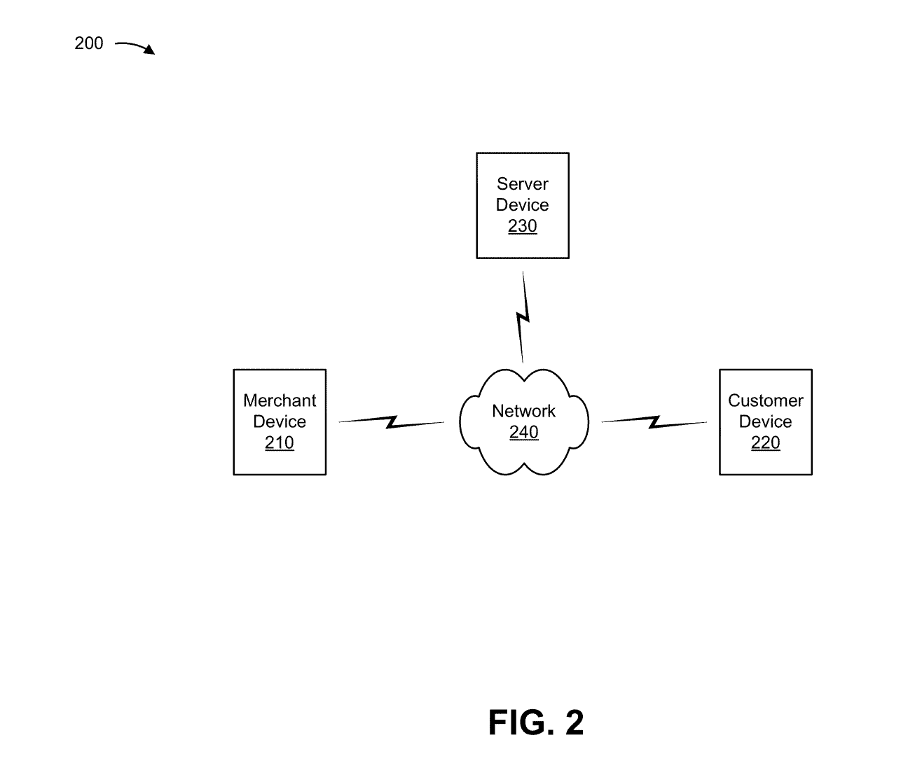

FIG. 2 is a diagram of an example environment 200 in which systems and/or methods described herein may be implemented. Environment 200 may include a merchant device 210, a customer device 220, a server device 230, and a network 240.

Merchant device 210 may include a computation and communication device that is capable of communicating with customer device 220, server device 230, and/or a network (e.g., network 240). For example, merchant device 210 may include a computer (e.g., a server, a personal computer, a desktop computer, a laptop computer, a tablet computer, etc.), a radiotelephone, a personal communications system terminal (e.g., that may combine a cellular radiotelephone with data processing and data communications capabilities), a personal digital assistant (e.g., that can include a radiotelephone, a pager, Internet/intranet access, etc.), a smart phone, and/or another type of computation and communication device. In some implementations, merchant device 210 may include a computer used to create, edit, activate, manage, and/or analyze a promotion.

Customer device 220 may include a computation and communication device that is capable of communicating with merchant device 210, server device 230, and/or a network (e.g., network 240). For example, customer device 220 may include a computer (e.g., a personal computer, a desktop computer, a laptop computer, a tablet computer, etc.), a radiotelephone, a personal communications system terminal (e.g., that may combine a cellular radiotelephone with data processing and data communications capabilities), a personal digital assistant (e.g., that can include a radiotelephone, a pager, Internet/intranet access, etc.), a smart phone, and/or another type of computation and communication device. In some implementations, customer device 220 may include a mobile device used to receive and/or interact with a promotion.

Server device 230 may include a computation and communication device that is capable of communicating with merchant device 210, customer device 220, and/or a network (e.g., network 240). For example, server device 230 may include a computer (e.g., a server, a personal computer, a desktop computer, a laptop computer, a tablet computer, etc.) and/or another type of computation and communication device. Additionally, or alternatively, server device 230 may include one or more traffic processing and/or traffic transfer devices, such as a gateway, a router, a modem, a switch, a firewall, a network interface card, a hub, a bridge, a proxy server, an optical add-drop multiplexer, a mobile hotspot device, a tethering device, or another type of device that processes and/or transfers traffic. In some implementations, server device 230 may facilitate communication between merchant device 210 and customer device 220. For example, server device 230 may receive a promotion from merchant device 210, and may provide the promotion to a target customer via customer device 220 at a user-specified time. Additionally, or alternatively, server device 230 may aggregate information associated with customer interactions with a promotion, and may provide recommendation to merchant device 210 based on the aggregated information.

Network 240 may include one or more wired and/or wireless networks. For example, network 240 may include a cellular network, a public land mobile network (“PLMN”), a second generation (“2G”) network, a third generation (“3G”) network, a fourth generation (“4G”) network, a fifth generation (“SG”) network, a long term evolution (“LTE”) network, and/or another network. Additionally, or alternatively, network 240 may include a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network (e.g., “FiOS”), and/or a combination of these or other types of networks.

The number of devices and/or networks illustrated in FIG. 2 is provided for explanatory purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, one or more of the devices of environment 200 may perform one or more functions described as being performed by another one or more of the devices of environment 200. Devices of environment 200 may interconnect via wired connections, wireless connections, or a combination of wired and wireless connections.

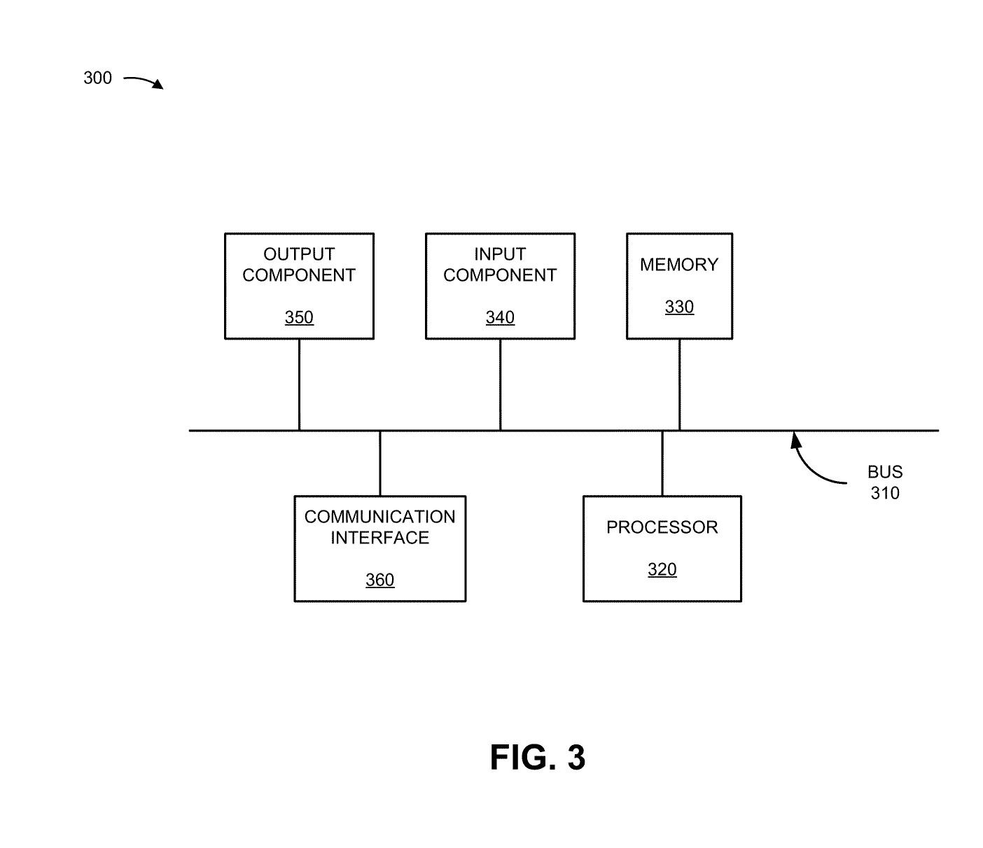

FIG. 3 is a diagram of example components of a device 300. Device 300 may correspond to merchant device 210, customer device 220, and/or server device 230. Additionally, or alternatively, each of merchant device 210, customer device 220, and/or server device 230 may include one or more devices 300 and/or one or more components of device 300.

Device 300 may include a bus 310, a processor 320, a memory 330, an input component 340, an output component 350, and a communication interface 360. In some implementations, device 300 may include additional components, fewer components, different components, or differently arranged components than those illustrated in FIG. 3.

Bus 310 may include a path that permits communication among the components of device 300. Processor 320 may include a processor, a microprocessor, and/or any processing logic (e.g., a field-programmable gate array (“FPGA”), an application-specific integrated circuit (“ASIC”), etc.) that interprets and executes instructions. Memory 330 may include a random access memory (“RAM”), a read only memory (“ROM”), and/or any type of dynamic or static storage device (e.g., a flash, magnetic, or optical memory) that stores information and/or instructions for use by processor 320.

Input component 340 may include any mechanism that permits a user to input information to device 300 (e.g., a keyboard, a keypad, a mouse, a button, a switch, etc.). Output component 350 may include any mechanism that outputs information from device 300 (e.g., a display, a speaker, one or more light-emitting diodes (“LEDs”), etc.).

Communication interface 360 may include any transceiver-like mechanism, such as a transceiver and/or a separate receiver and transmitter, that enables device 300 to communicate with other devices and/or systems, such as via a wired connection, a wireless connection, or a combination of wired and wireless connections. For example, communication interface 360 may include a mechanism for communicating with another device and/or system via a network, such as network 240. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions contained in a computer-readable medium, such as memory 330. A computer-readable medium may be defined as a non-transitory memory device. A memory device may include space within a single storage device or space spread across multiple storage devices.

Software instructions may be read into memory 330 from another computer-readable medium or from another device via communication interface 360. Software instructions stored in memory 330 may cause processor 320 to perform processes that are described herein. Additionally, or alternatively, hardwired circuitry may be used in place of or in combination with software instructions to implement processes described herein. Thus, implementations described herein are not limited to any specific combination of hardware circuitry and software.

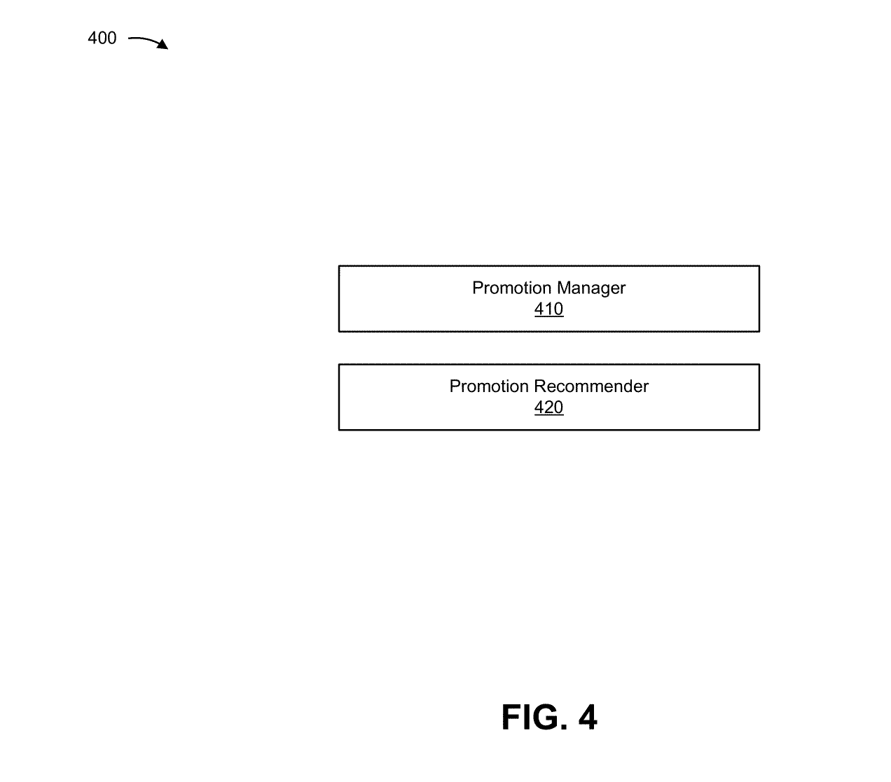

FIG. 4 is a diagram of example functional components of a device 400 that may correspond to merchant device 210 and/or server device 230. Device 400 may include a promotion manager 410 and a promotion recommender 420. Functional components 410-420 may be implemented using one or more devices 300 or one or more components of device 300. Merchant device 210 and/or server device 230 may individually include all of the functional components depicted in FIG. 4, or the functional components depicted in FIG. 4 may be distributed singularly or duplicatively in any manner between the devices illustrated in FIG. 2. In some implementations, merchant device 210 and/or server device 230 may include other functional components (not shown) that aid in creating, editing, activating, managing, analyzing, and/or recommending a promotion.

Promotion manager 410 may perform operations associated with creating, editing, activating, managing, and/or analyzing a promotion. Promotion recommender 420 may perform operations associated with aggregating and/or analyzing information associated with a promotion (e.g., customer interaction information). Additionally, or alternatively, promotion recommender 420 may perform operations associated with providing a promotion recommendation.

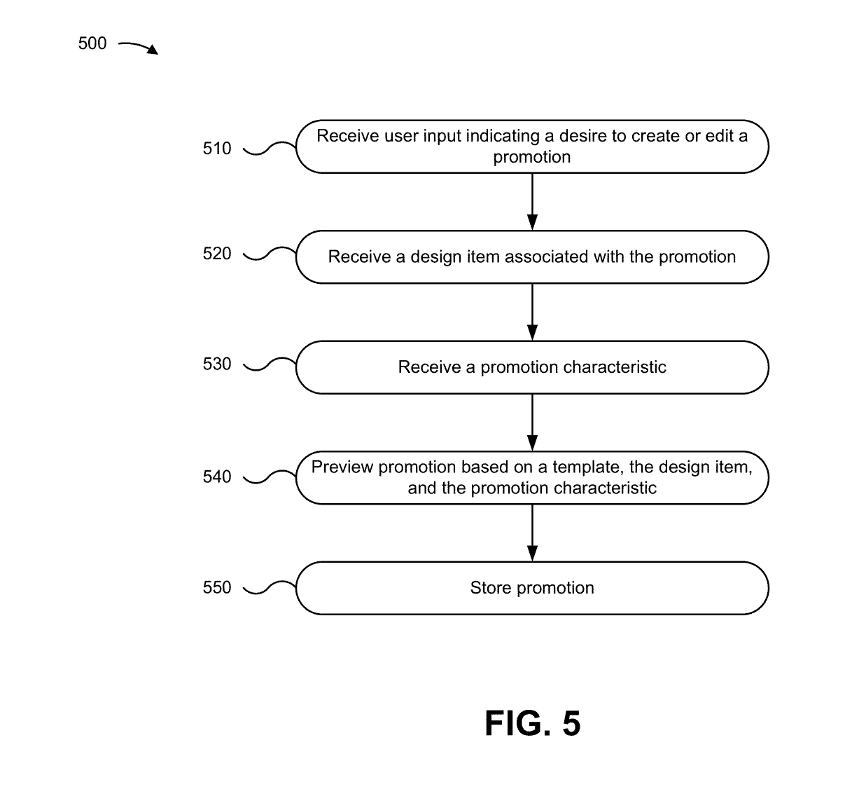

FIG. 5 is a diagram of an example process 500 for creating a promotion according to an implementation described herein. In some implementations, one or more process blocks of FIG. 5 may be performed by one or more components of merchant device 210 and/or server device 230.

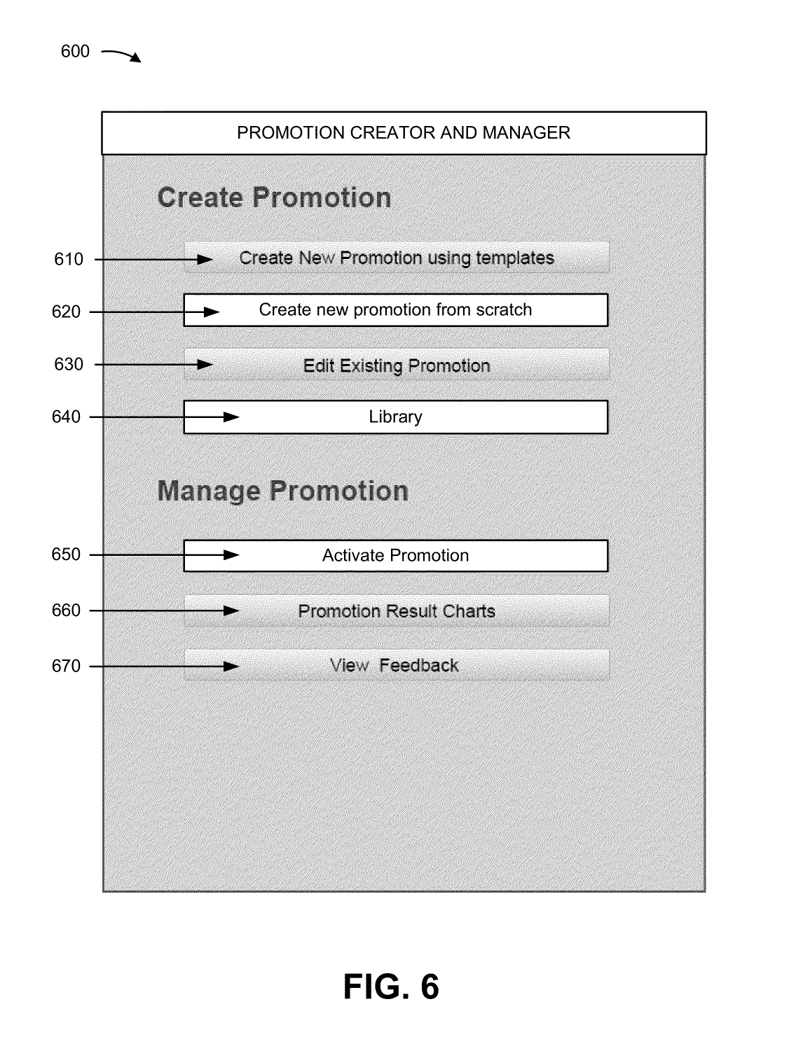

As shown in FIG. 5, process 500 may include receiving user input indicating a desire to create or edit a promotion (block 510). In some implementations, promotion manager 410 may receive user input (e.g., via a button, a text box, a link, a menu, etc.) indicating that a user wants to create and/or edit a promotion. Additionally, or alternatively, promotion manager 410 may receive user input indicating a user desire to create a promotion using a template, to create a promotion from scratch, and/or to edit an existing promotion. For example, a user may indicate a desire to create a promotion via user interface 600, discussed below in connection with FIG. 6.

FIG. 6 is a diagram of an example user interface 600 for receiving user input to create a promotion. In some implementations, user interface 600 may be displayed by merchant device 210. As illustrated, user interface 600 may include a group of buttons relating to creating a promotion and a group of buttons relating to managing a promotion. The group of buttons relating to creating a promotion may include a template button 610, a create from scratch button 620, an edit button 630, and a library button 640. The group of buttons relating to managing a promotion may include an activation button 650, a report button 660, and a feedback button 670. In some implementations, user interface 600 may include fewer buttons, additional buttons, different buttons, or differently arranged buttons than those illustrated in FIG. 6.

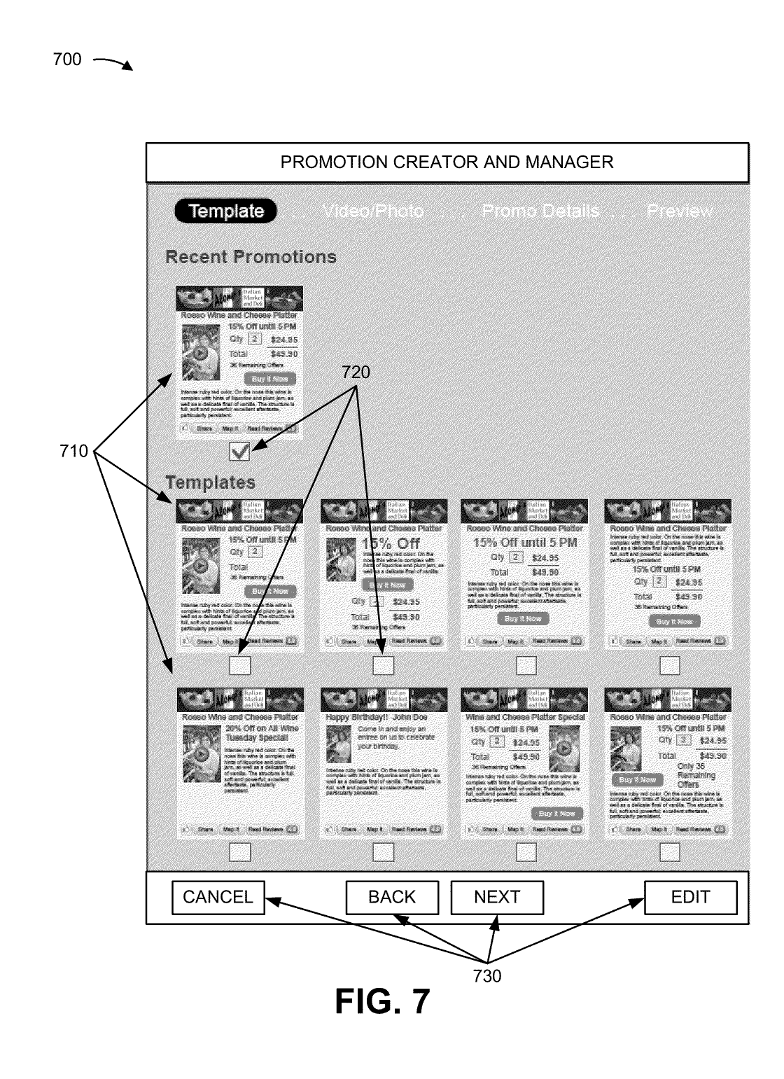

Template button 610 may provide a mechanism (e.g., a button, an icon, a link, a text box, etc.) for a user to indicate a desire to create a promotion using a template. User selection of template button 610 may cause merchant device 210 to display a user interface, such as user interface 700, discussed below in connection with FIG. 7.

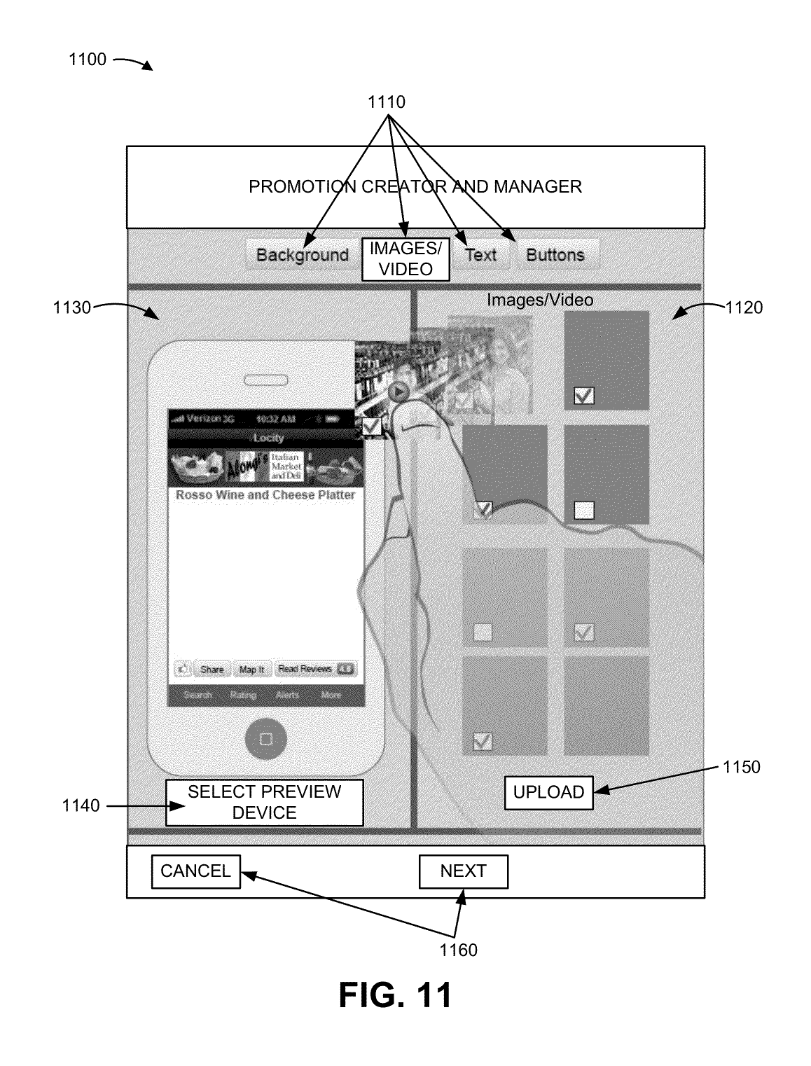

Create from scratch button 620 may provide a mechanism for a user to indicate a desire to create a promotion from scratch, as discussed below in connection with FIG. 11.

Edit button 630 may provide a mechanism for a user to indicate a desire to edit a previously-activated promotion. For example, a promotion may be ongoing (e.g., scheduled for a current date). User selection of edit button 630 may allow a user to edit the ongoing promotion (e.g., via user interfaces 700-1100, discussed below in connection with FIGS. 7-11).

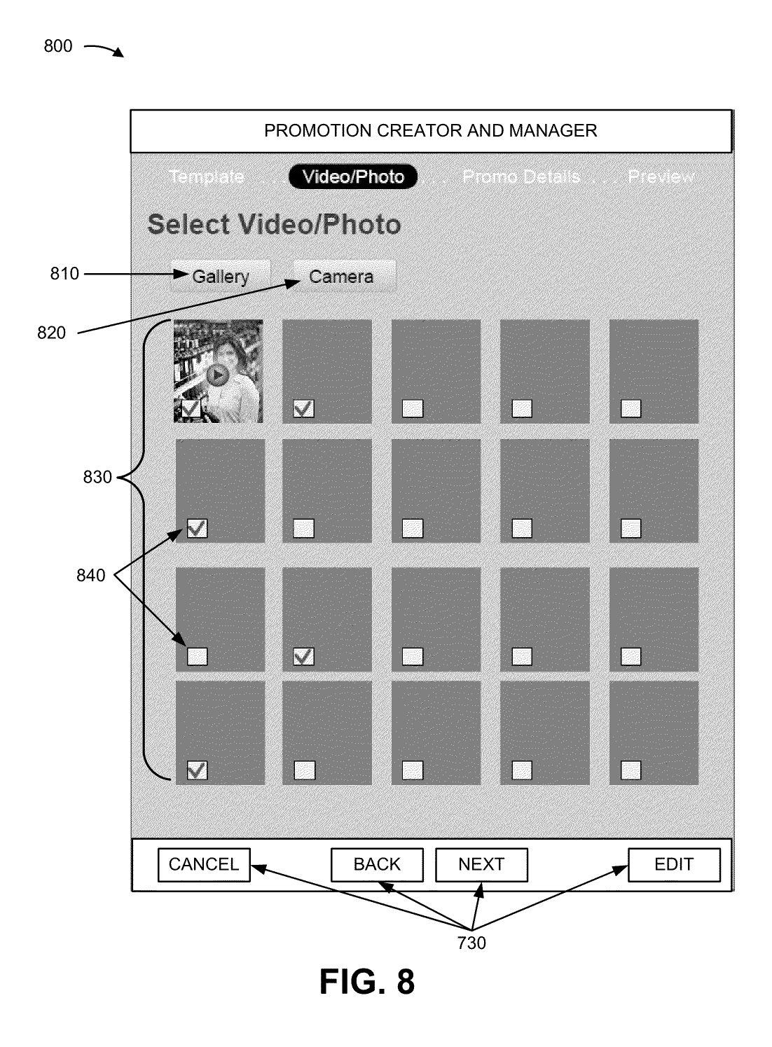

Library button 640 may provide a mechanism for a user to view and/or add design items to a library of stored design items. For example, user selection of library button 640 may launch a user interface (e.g., similar to user interface 800, discussed below in connection with FIG. 8), and may allow a user to upload different categories of design items.

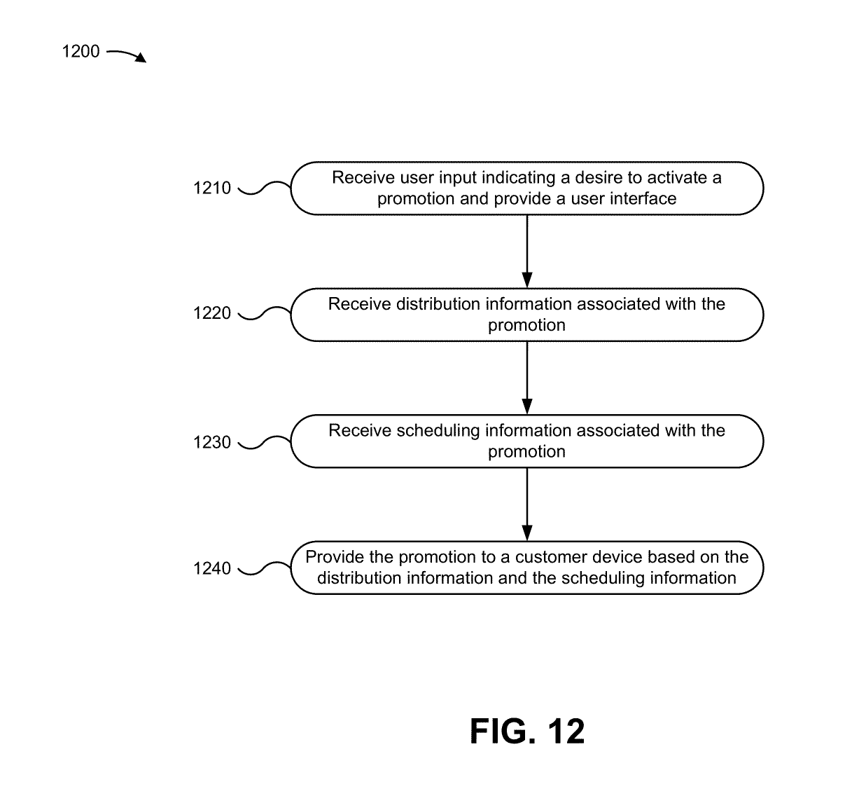

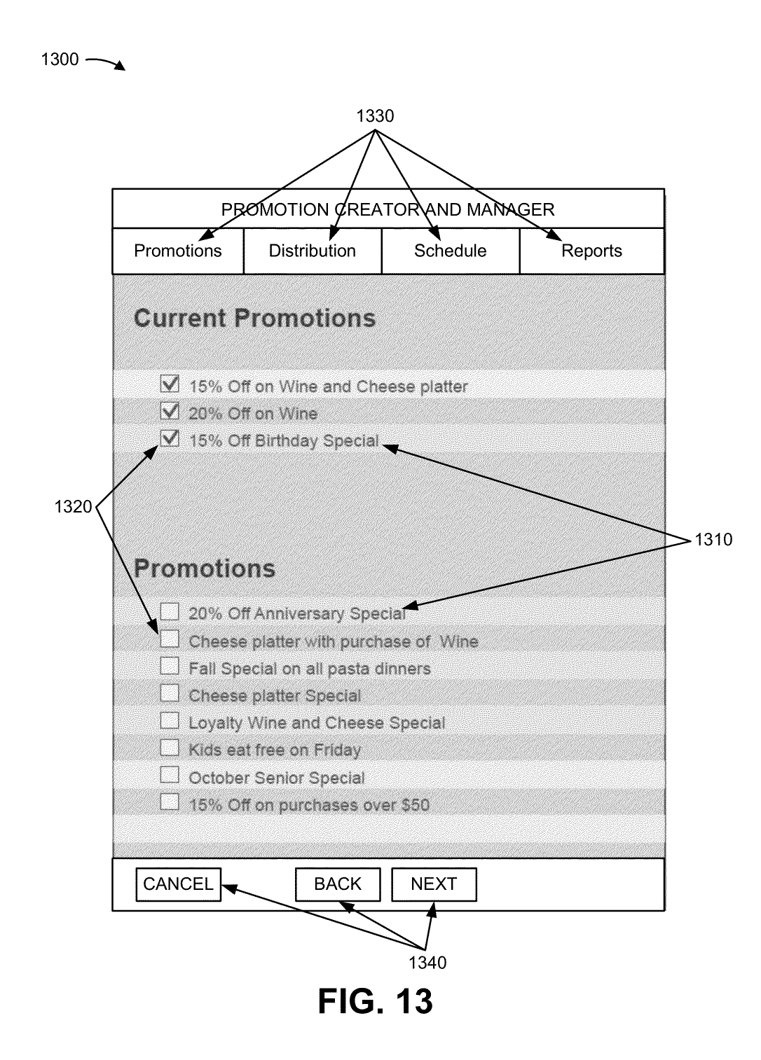

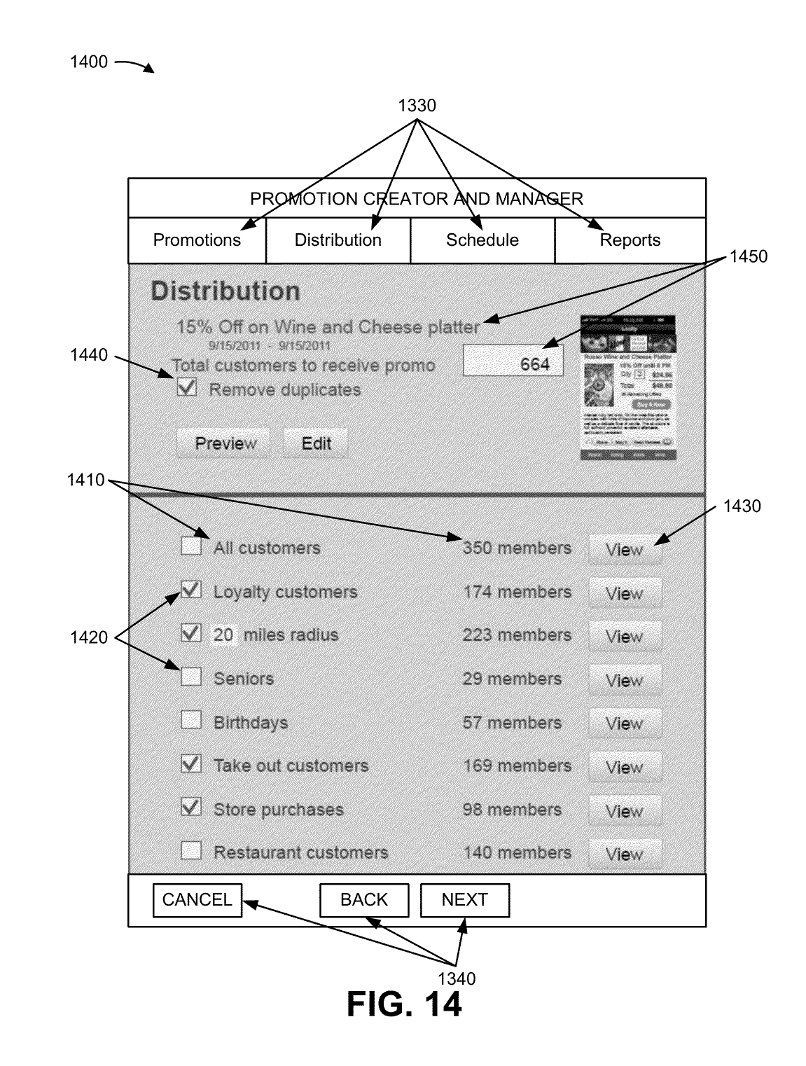

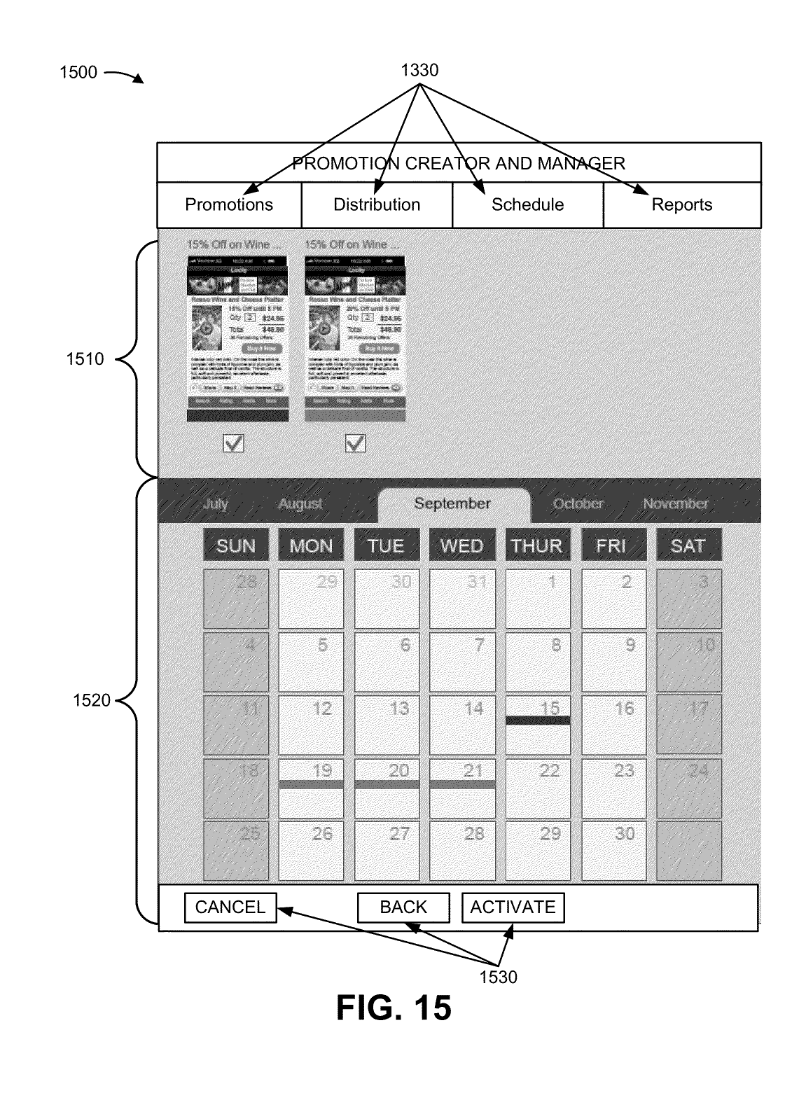

Activation button 650 may provide a mechanism (e.g., a button, an icon, a link, etc.) for a user to indicate a desire to activate a promotion (e.g., to select target customers for a promotion, as discussed below in connection with FIG. 14, and/or to schedule a promotion, as discussed below in connection with FIG. 15). In some implementations, user selection of activation button 650 may cause merchant device 210 to launch a user interface that may assist the user in activating a promotion (e.g., user interfaces 1300-1500, as discussed below in connection with FIGS. 13-15). Further details regarding the activation of a promotion are discussed below in connection with process 1200 of FIG. 12.

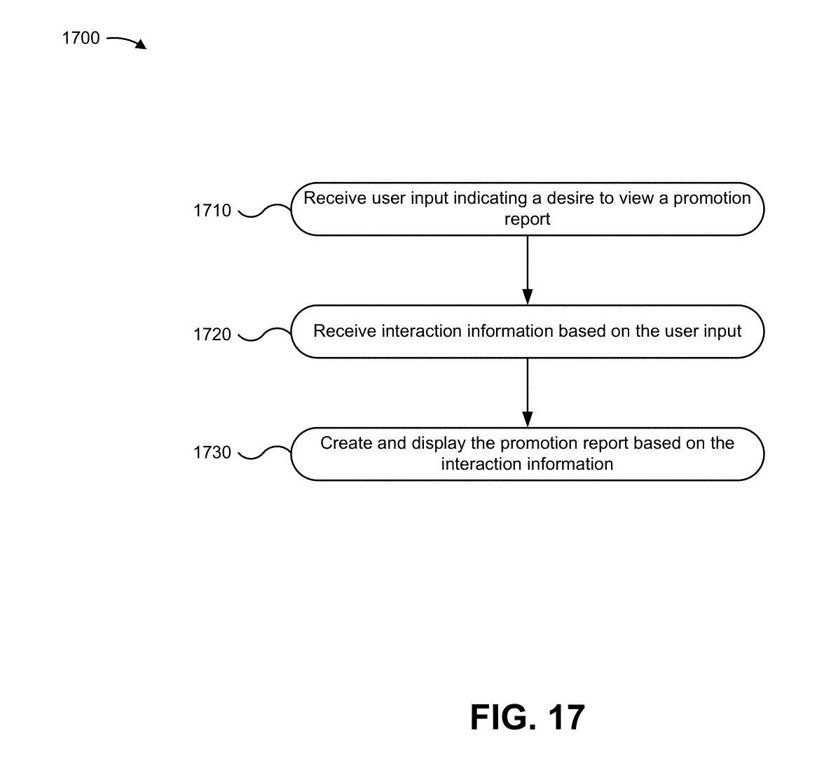

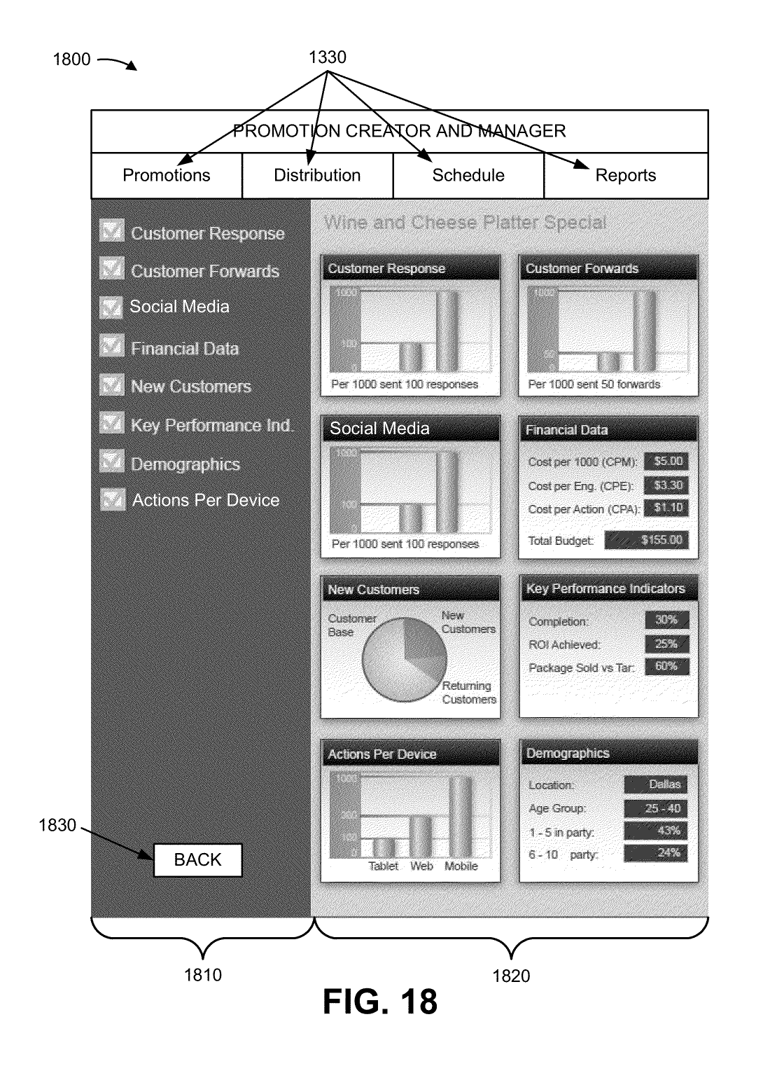

Report button 660 may provide a mechanism (e.g., a button, an icon, a link, etc.) for a user to indicate a desire to view a promotion report. In some implementations, user selection of report button 660 may cause merchant device 210 to launch a user interface that may display a promotion report (e.g., user interfaces 1800, as discussed below in connection with FIG. 18). Further details regarding the creation of a promotion report are discussed below in connection with process 1700 of FIG. 17.

Feedback button 670 may provide a mechanism (e.g., a button, an icon, a link, etc.) for a user to indicate a desire to view customer feedback associated with a promotion. For example, a customer may have the option to provide feedback associated with a promotion (e.g., via customer device 220). Promotion manager 410 may receive customer feedback in connection with a promotion, and may associate the received feedback with information identifying the promotion. In some implementations, user selection of feedback button 670 may cause merchant device 210 to launch a user interface that may display customer feedback received and/or stored by promotion manager 410.

Returning to FIG. 5, process 500 may include receiving a design item associated with the promotion (block 520). A design item may specify an item that may be used to design a promotion. For example, a design item may include text, an image, a video, an animation, an input element, a layout, a template, an appearance of a promotion, etc. In some implementations, promotion manager 410 may receive the design item via one or more user interfaces, (e.g., user interface 700 and/or user interface 800, discussed below in connection with FIGS. 7 and 8).

FIG. 7 is a diagram of an example user interface 700 for selecting a template for use in creating a promotion. In some implementations, user interface 700 may be displayed by merchant device 210. Additionally, or alternatively, user interface 700 may be displayed based on user selection of template button 610. As illustrated, user interface 700 may include a template display element 710, a template selection element 720, and a user input element 730. In some implementations, user interface 700 may include less information, additional information, different information, or differently arranged information than illustrated in FIG. 7.

Template display element 710 may display a template for a promotion. A template may include one or more design items (e.g., text, an image, a video, an input element, etc.) and/or a layout of design items. In some implementations, promotion manager 410 may store a template (e.g., in memory). Template display element 710 may display a set of stored templates based on a merchant creating the promotion, a merchant device being used to create the promotion, a promotion characteristic, etc. Additionally, or alternatively, template display element 710 may display a set of recently used templates (e.g., a set of most recently used templates, a set of templates used during a particular time period, a set of templates used by a particular merchant, a set of templates used on a particular merchant device, a set of templates relating to a particular product and/or service, etc.). Additionally, or alternatively, template display element 710 may provide a mechanism (e.g., a text box, a button, etc.) for a user to search for a template based on one or more characteristics of the template.

Template selection element 720 may include a mechanism (e.g., a button, a checkbox, a link, etc.) for a user to indicate a desire to use a displayed template to create a promotion.

User input element 730 may provide a mechanism (e.g., a button, a menu item, etc.) for a user to change the displayed user interface. For example, user input element 730 may provide a mechanism (e.g., a “CANCEL” button) for a user to cancel promotion creation, which may, for example, cause user interface 600 to be displayed. Additionally, or alternatively, user input element 730 may provide a mechanism (e.g., a “BACK” button) for a user to return to a previous user interface (e.g., user interface 600) in the promotion creation process. Additionally, or alternatively, user input element 730 may provide a mechanism (e.g., a “NEXT” button) for a user to proceed to a next user interface in the promotion creation process (e.g., user interface 800). Additionally, or alternatively, user input element 730 may provide a mechanism (e.g., an “EDIT” button) for a user to edit a selected template, which will be described in further detail below in connection with FIG. 11.

FIG. 8 is a diagram of an example user interface 800 for obtaining design items that may be included in a promotion. In some implementations, user interface 800 may be displayed by merchant device 210. As illustrated, user interface 800 may include a gallery button 810, a camera button 820, a display area 830, a selection box 840, and a user input element 730. In some implementations, user interface 800 may include less information, additional information, different information, or differently arranged information than illustrated in FIG. 8.

In some implementations, user interface 800 may be displayed based on user selection of a “NEXT” button on user interface 700. For example, a user may select a template via user interface 700, and may select design items to be included in the template via user interface 800. For example, a template may specify an area for a video to be displayed, and a user may select and/or input a video, via user interface 800, to be displayed in the specified area. Additionally, or alternatively, a template may specify an area and/or a style (e.g., a size, a font, a color, etc.) for any design item (e.g., text, an image, a video, an animation, etc.).

Gallery button 810 may include a mechanism (e.g., a button, a menu item, etc.) for a user to input a design item for display on user interface 800 (e.g., for display via display area 830). For example, gallery button 810 may provide a mechanism for a user to access a stored design item (e.g., a design item stored by merchant device 210 and/or service device 230), and may provide a mechanism for a user to select a set of stored design items to display on user interface 800.

Camera button 820 may provide a mechanism (e.g., a button, a menu item, etc.) for a user to capture a design item using a camera (e.g., a picture camera and/or video camera associated with merchant device 210). The captured design item may be displayed in display area 830. In some implementations, user interface 800 may provide a mechanism for a user to input other design items other than a video or an image (e.g., text via a keyboard).

Display area 830 may display one or more design items (e.g., user-input design items) for selection by a user. In some implementations, promotion manager 410 may store a design item (e.g., in memory). Display area 830 may display a set of stored design items based on a merchant creating the promotion, a merchant device being used to create the promotion, a promotion characteristic, etc. Additionally, or alternatively, display area 830 may display recently used design items (e.g., a set of most recently used design items, a set of design items used during a particular time period, etc.). Additionally, or alternatively, display area 830 may display a set of user-input design items (e.g., a design item input using a picture camera, a video camera, a keyboard, and/or another input mechanism). Additionally, or alternatively, display area 830 may display one or more design items based on the template selected in connection with user interface 700. Additionally, or alternatively, display area 830 may display a set of design items based on a user search for a characteristic of a design item.

Selection box 840 may include a mechanism (e.g., a button, a checkbox, a link, etc.) for a user to indicate a desire to use a design item to create and/or edit a promotion (e.g., to add a design item to a promotion). In some implementations, user selection of a design item via selection box 840 may cause the selected design item to be added to a template (e.g., a template selected via user interface 700). Additionally, or alternatively, a user may double click (or perform another action) on a design item to cause the design item to be added to a template.

User input element 730 may provide a mechanism (e.g., a button, a menu item, etc.) for a user to change the displayed user interface. For example, user input element 730 may provide a mechanism (e.g., a “CANCEL” button) for a user to cancel promotion creation, which may, for example, cause user interface 600 to be displayed. Additionally, or alternatively, user input element 730 may provide a mechanism (e.g., a “BACK” button) for a user to return to a previous user interface (e.g., user interface 700) in the promotion creation process. Additionally, or alternatively, user input element 730 may provide a mechanism (e.g., a “NEXT” button) for a user to proceed to a next user interface in the promotion creation process (e.g., user interface 900). Additionally, or alternatively, user input element 730 may provide a mechanism (e.g., an “EDIT” button) for a user to edit a selected design item, which will be described in further detail below in connection with FIG. 11.

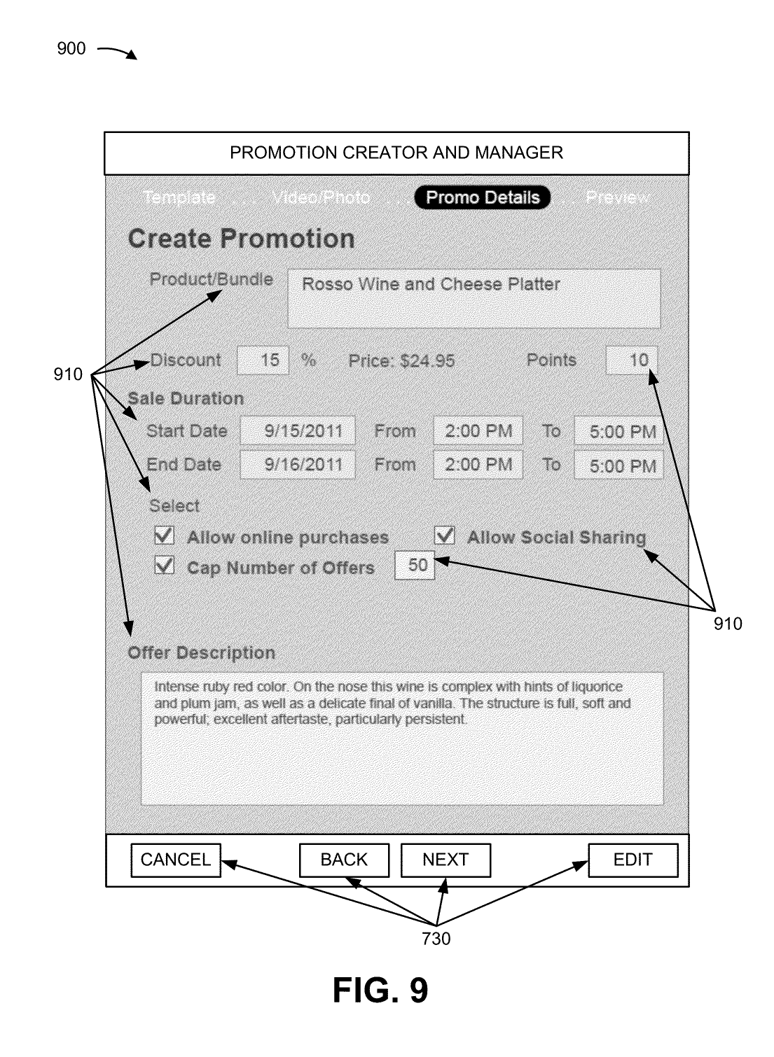

In some implementations, user selection of the NEXT button may cause user interface 800 to allow user selection of a different design item. For example, a user may select a video to include in a template. The user may then click the NEXT button, and user interface 800 may allow a user to select an image or text to include in the template. Additionally, or alternatively, user selection of the NEXT button may display an interface that allows a user to indicate that the user is finished selecting design items to include in a template. In this implementation, user select of the NEXT button may cause merchant device 210 to display another user interface, such as user interface 900, discussed below in connection with FIG. 9.

Returning to FIG. 5, process 500 may include receiving a promotion characteristic (block 530). A promotion characteristic may include a product and/or a service associated with a promotion, a discount and/or a price associated with a promotion, a quantity of customer loyalty points associated with a promotion, a start date and/or start time of a promotion, an end date and/or end time of a promotion, a duration of a promotion, an inventory count associated with a promotion (e.g., a quantity of promotions that will be available for purchase by one or more customers), a description of a promotion, a promotion option, and/or another characteristic associated with a promotion. A promotion option may include, for example, information relating to whether or not to allow online (e.g., out of store) purchases, whether or not to allow sharing of a promotion (e.g., sharing via text message, sharing via email, sharing via social media, etc.). In some implementations, promotion manager 410 may receive the promotion characteristic via a user interface, as discussed herein in connection with FIG. 9.

FIG. 9 is a diagram of an example user interface 900 for adding a promotion characteristic to a promotion. In some implementations, user interface 900 may be displayed by merchant device 210. As illustrated, user interface 900 may include one or more characteristic items 910, and a user input element 730. In some implementations, user interface 900 may include less information, additional information, different information, or differently arranged information than illustrated in FIG. 9.

In some implementations, user interface 900 may be displayed based on user selection of a “NEXT” button on user interface 800. For example, a user may select a template via user interface 700, may select design items to be added to the template via user interface 800, and may select promotion characteristics to be included in a promotion associated with the template via user interface 900.

Characteristic item 910 may include a mechanism (e.g., a button, a text box, a check box, a menu item, a link, etc.) for a user to input a promotion characteristic to be included in a promotion. For example, characteristic item 910 may provide a mechanism for a user to input a promotion name, a product associated with a promotion, and/or a service associated with a promotion (e.g., “Rosso Wine and Cheese Platter,” as illustrated). Additionally, or alternatively, characteristic item 910 may provide a mechanism for a user to input a discount (e.g., “15%,” as illustrated) and/or a price (e.g., “$24.95,” as illustrated) associated with a promotion. Additionally, or alternatively, characteristic item 910 may provide a mechanism for a user to input a quantity of customer loyalty points (e.g., “10,” as illustrated) associated with a promotion. When a customer interacts with a promotion (e.g., by purchasing the product and/or service advertised in the promotion, by forwarding and/or sharing the promotion, by interacting with the promotion using a social media application or web site, etc.), the customer may receive the quantity of customer loyalty points input via characteristic item 910.

Additionally, or alternatively, characteristic item 910 may provide a mechanism for a user to input a start date (e.g., “Sep. 15, 2011,” as illustrated) and/or an end date (e.g., “Sep. 16, 2011,” as illustrated) associated with a promotion. Additionally, or alternatively, characteristic item 910 may provide a mechanism for a user to input a start time (e.g., “2:00 PM,” as illustrated) and/or an end time (e.g., “5:00 PM,” as illustrated) associated with a promotion. In some implementations, characteristic item 910 may provide a mechanism for a user to input a start time and/or an end time associated with the entire promotion period. Additionally, or alternatively, characteristic item 910 may provide a mechanism for a user to input a start time and/or an end time associated with one or more dates on which the promotion is active.

Additionally, or alternatively, characteristic item 910 may provide a mechanism for a user to input a purchasing option associated with a promotion. A purchasing option may include an indication of whether a user may purchase a product and/or service associated with a promotion at a merchant location (e.g., in a merchant store), whether a user may purchase a product and/or service associated with a promotion using a merchant website (e.g., online), whether a user may purchase a product and/or service associated with a promotion using a text message (e.g., via short messaging service (“SMS”) and/or multimedia messaging service (“MMS”)), whether a user may purchase a product and/or service associated with a promotion using e-mail, etc.

Additionally, or alternatively, characteristic item 910 may provide a mechanism for a user to input a sharing option associated with a promotion. A sharing option may include an indication of whether a user may share a promotion via text message, whether a user may share a promotion via e-mail, whether a user may share a promotion via social media (e.g., using a particular social media application and/or website), etc.

Additionally, or alternatively, characteristic item 910 may provide a mechanism for a user to input an inventory count associated with a promotion. An inventory count may include a quantity of products and/or services, advertised in the promotion, that are available during the promotion period (e.g., “50,” as illustrated). In the example illustrated in FIG. 9, the promotion may end once 50 customers have purchased a product and/or service associated with the promotion. Additionally, or alternatively, an inventory count may include a quantity of products and/or services, advertised in the promotion, that must be purchased for the promotion to take effect. In the example illustrated in FIG. 9, the 15% discount may not take effect until 50 customers have purchased a product and/or service associated with the promotion.

Additionally, or alternatively, characteristic item 910 may provide a mechanism for a user to input a discount and/or a price associated with a date, a time, and/or an inventory count. For example, a user may input a first discount and/or a first price associated with a promotion on a first date and/or at a first time, and may input a second discount and/or a second price associated with the promotion on a second date and/or at a second time. Similarly, a user may input a first discount and/or a first price associated with a promotion at a first inventory level (e.g., a first quantity of unpurchased products and/or services associated with the promotion), and may input a second discount and/or a second price associated with the promotion at a second inventory level (e.g., a second quantity of unpurchased products and/or services associated with the promotion). Additionally, or alternatively, a user may use a combination of date, time, and/or inventory level to set a discount and/or a price associated with a promotion.

For example, a user may specify an initial discount of 15%, and an initial inventory count of 50. The user may specify that the discount be increased (e.g., to 25%) if 30 or more units of inventory remain unpurchased on the second day of the promotion (or at 3:00 on the second day of the promotion, etc.). A user may use any combination of date, time, and/or inventory level to set multiple discounts and/or prices associated with the promotion.

Additionally, or alternatively, characteristic item 910 may provide a mechanism for a user to input a description associated with a promotion (e.g., “Intense ruby red color,” as illustrated).

User input element 730 may provide a mechanism (e.g., a button, a menu item, etc.) for a user to change the displayed user interface. For example, user input element 730 may provide a mechanism (e.g., a “CANCEL” button) for a user to cancel promotion creation, which may, for example, cause user interface 600 to be displayed. Additionally, or alternatively, user input element 730 may provide a mechanism (e.g., a “BACK” button) for a user to return to a previous user interface (e.g., user interface 800) in the promotion creation process. Additionally, or alternatively, user input element 730 may provide a mechanism (e.g., a “NEXT” button) for a user to proceed to a next user interface in the promotion creation process (e.g., user interface 1000). Additionally, or alternatively, user input element 730 may provide a mechanism (e.g., an “EDIT” button) for a user to edit a selected promotion characteristic, which will be described in further detail below in connection with FIG. 11.

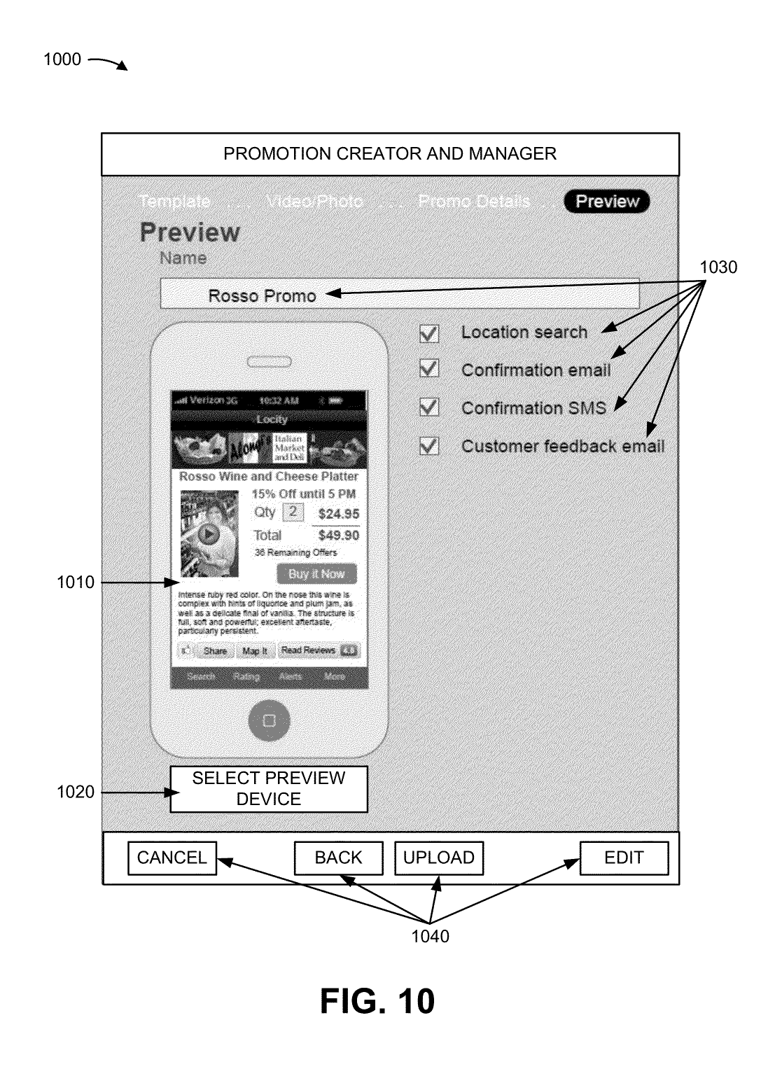

Returning to FIG. 5, process 500 may include previewing a promotion based on the template, the design item, and the promotion characteristic (block 540). In some implementations, promotion manager 410 may display a promotion that includes user-input design items and user-input promotion characteristics. For example, promotion manager 410 may display the promotion on a user interface, as discussed herein in connection with FIG. 10.

FIG. 10 is a diagram of an example user interface 1000 for previewing a created promotion. In some implementations, user interface 1000 may be displayed by merchant device 210. As illustrated, user interface 1000 may include a preview area 1010, a device button 1020, an option element 1030, and a user input element 1040. In some implementations, user interface 1000 may include less information, additional information, different information, or differently arranged information than illustrated in FIG. 10.

In some implementations, user interface 1000 may be displayed based on user selection of a “NEXT” button on user interface 900. For example, a user may select a template for a promotion via user interface 700, may select design items to be included in the promotion via user interface 800, may select promotion characteristics associated with the promotion via user interface 900, and may preview the promotion via user interface 1000.

Preview area 1010 may display a promotion created by a user. The displayed promotion may include a layout (e.g., a layout specified by a template selected via user interface 700) of design items (e.g., design items selected via user interface 800), and one or more promotion characteristics (e.g., promotion characteristics input via user interface 900).

Device button 1020 may provide a mechanism (e.g., a button, a drop-down box, a menu item, etc.) for a user to specify a device on which to preview the promotion. For example, a user may select a phone (and/or a particular phone type and/or model), a personal computer, a tablet computer, a laptop, etc. Preview area 1010 may display the promotion based on how the promotion would appear on the user-specified device.

Option element 1030 may provide a mechanism (e.g., a checkbox, a text box, a menu item, an icon, etc.) for a user to input options associated with a displayed promotion. For example, option element 1030 may provide a mechanism for a user to input a name for the displayed promotion. The input name may be used to identify the displayed promotion so that the user can access the displayed promotion as a template after it has been created (e.g., via user interface 700). Additionally, or alternatively, option element 1030 may provide a mechanism for a user to input whether to allow a customer to search for the promotion based on a customer location (e.g., a geographic positioning signal (“GPS”) location associated with customer device 220).

Additionally, or alternatively, option element 1030 may provide a mechanism for a user to input whether to send a confirmation text message and/or a confirmation e-mail to a customer once the customer has purchased the products and/or services associated with the promotion. Additionally, or alternatively, option element 1030 may provide a mechanism for a user to input whether to send an e-mail requesting customer feedback to a customer that has purchased the products and/or services associated with the promotion.

User input element 1040 may provide a mechanism (e.g., a button, a menu item, etc.) for a user to change the displayed user interface. For example, user input element 1040 may provide a mechanism (e.g., a “CANCEL” button) for a user to cancel promotion creation, which may, for example, cause user interface 600 to be displayed. Additionally, or alternatively, user input element 1040 may provide a mechanism (e.g., a “BACK” button) for a user to return to a previous user interface (e.g., user interface 900) in the promotion creation process. Additionally, or alternatively, user input element 1040 may provide a mechanism (e.g., an “UPLOAD” button) for a user to finish promotion creation and upload the created promotion (e.g., for storage via promotion manager 410). Additionally, or alternatively, user input element 1040 may provide a mechanism (e.g., an “EDIT” button) for a user to edit a selected template, which will be described in further detail below in connection with FIG. 11.

Returning to FIG. 5, process 500 may include storing the promotion (block 550). In some implementations, promotion manager 410 may store the promotion so that it can be activated (e.g., delivered to a target customer at a user-specified time and/or location). For example, a promotion may be stored based on user selection of an UPLOAD button on user interface 1000.

FIG. 11 is a diagram of an example user interface 1100 for creating a promotion from scratch and/or editing a promotion. In some implementations, user interface 1100 may be displayed by merchant device 210. As illustrated, user interface 1100 may include one or more input type buttons 1110, a display area 1120, a preview area 1130, a device button 1140, an upload button 1150, and a user input element 1160. In some implementations, user interface 1100 may include less information, additional information, different information, or differently arranged information than illustrated in FIG. 11.

In some implementations, user interface 1100 may be displayed based on user selection of create from scratch button 620. Additionally, or alternatively, user interface 1100 may be displayed based on user selection of an EDIT button on user interfaces 700-1000. For example, a user may select a template via user interface 700, and may edit the template via user interface 1100. Additionally, or alternatively, a user may select a design item via user interface 800, and may edit the design item via user interface 1100. Additionally, or alternatively, a user may specify a promotion characteristic via user interface 900, and may edit the appearance of the promotion characteristic on a promotion via user interface 1100. Additionally, or alternatively, a user may preview a promotion via user interface 1000, and may edit the appearance of the previewed promotion via user interface 1100.

Input type buttons 1110 may include a mechanism (e.g., a button, an icon, a menu item, etc.) for a user to select a design item type. A design item type may include text, an image, a video, a background (e.g., a background image), an input element (e.g., a button, a checkbox, etc.), etc. User selection of an input type button 1110 may cause display area 1120 to display one or more design items based on the user input. For example, user selection of “images/video” via input type button 1110 may cause one or more images and/or videos to be displayed via display area 1120. User selection of “background” via input type button 1110 may cause one or more backgrounds (e.g., a background image) to be displayed via display area 1120. User selection of “input elements” via input type button 1110 may cause one or more predetermined input elements (e.g., a textbox, a check box, a button with a predetermined text label, size, shape, etc.) to be displayed via display area 1120.

User selection of “text” via input type button 1110 may cause one or more predetermined text items (e.g., a text box, a string of characters, etc.) to be displayed via display area 1120. Additionally, or alternatively, user selection of “text” via input type button 1110 may allow a user to input text, and may cause one or more text styles (e.g., font, color, size, etc.) to be displayed via display area 1120. The user may select a text style, and apply that style to selected text.

Display area 1120 may display a design item for a user to include in a promotion. A design item displayed by display area 1120 may be based on user input via input type buttons 1110. In some implementations, display area 1120 may provide a mechanism (e.g., a drag and drop mechanism via a touch screen, a click and drag mechanism, a button, a checkbox, etc.) for a user to indicate a desire to include a design item in a promotion. For example, a user may drag and drop an image displayed by display area 1120 to preview area 1130, as illustrated.

Preview area 1130 may display a promotion that is being created by a user. The displayed promotion may include design items and/or a layout of the design items. In some implementations, preview area 1130 may provide a mechanism (e.g., a drag and drop mechanism via a touch screen, a button, a click and drag mechanism, etc.) for a user to add, remove, and/or edit (e.g., move, resize, zoom, reword, rearrange, etc.) a design item displayed via preview area 1130 (and/or display area 1120).

Device button 1140 may provide a mechanism (e.g., a button, a drop-down box, a menu item, etc.) for a user to specify a device on which to preview the promotion. For example, a user may select a phone (and/or a particular phone type and/or model), a personal computer, a tablet computer, a laptop, etc. Preview area 1130 may display the promotion based on how the promotion would appear on the user-specified device. Thus, the user may design exactly how a promotion will be displayed via different types of devices.

Upload button 1150 may provide a mechanism (e.g., a button, a menu item, etc.) for a user to display additional design items via display area 1120. In some implementations, upload button 1150 may allow a user to search and/or browse a device (e.g., merchant device 210) and/or the Internet to add design items for display via display area 1120. Additionally, or alternatively, user selection of upload button 1150 may cause merchant device 210 to display user interface 900, which may allow a user to select or capture a design item to include in display area 1120.

User input element 1160 may provide a mechanism (e.g., a button, a menu item, etc.) for a user to change the displayed user interface. For example, user input element 1160 may provide a mechanism (e.g., a “CANCEL” button) for a user to cancel promotion editing (e.g., return to a user interface, from which a user launched user interface 1100, without editing the promotion). Additionally, or alternatively, user input element 1160 may provide a mechanism (e.g., a “NEXT” button) for a user to proceed to a next user interface in the promotion creation process (e.g., return to a user interface, from which a user launched user interface 1100, and using the edited promotion).

FIG. 12 is a diagram of an example process 1200 for activating a promotion. In some implementations, one or more process blocks of FIG. 12 may be performed by one or more components of merchant device 210 and/or server device 230.

As shown in FIG. 12, process 1200 may include receiving user input indicating a desire to activate a promotion and provide a user interface (block 1210). In some implementations, promotion manager 410 may receive user input (e.g., via a button, a text box, a link, a menu, etc.) indicating that a user wants to activate a promotion (e.g., via activation button 650). For example, promotion manager 410 may provide a user interface, such as user interface 1300 of FIG. 13.

FIG. 13 is a diagram of an example user interface 1300 for selecting a promotion for activation. In some implementations, user interface 1300 may be displayed by merchant device 210. Additionally, or alternatively, user interface 1300 may be displayed based on user selection of activation button 650. As illustrated, user interface 1300 may include a group of elements relating to ongoing promotions, and a group of elements relating to promotions that are not ongoing. Each group may include a promotion identifier element 1310 and a promotion selection element 1320. Additionally, user interface 1300 may include interface tabs 1330 and a user input element 1340. In some implementations, user interface 1300 may include less information, additional information, different information, or differently arranged information than illustrated in FIG. 13.

Promotion identifier element 1310 may display an identifier associated with a promotion. In some implementations, promotion manager 410 may store a promotion (e.g., a promotion created by a user). Additionally, or alternatively, promotion identifier element 1310 may display an identifier (e.g., a name) associated with a promotion stored by promotion manager 410. Additionally, or alternatively, promotion identifier element 1310 may display recently created promotions (e.g., a set of most recently created promotions, a set of promotions created during a particular time period, etc.) and/or promotions that are currently active (e.g., promotions that are active at a current date and/or time).

Promotion selection element 1320 may include a mechanism (e.g., a button, a checkbox, a link, etc.) for a user to indicate a desire to activate, distribute, and/or schedule a promotion. For example, a user may select a displayed promotion, and may use user input element 1340 to input distribution information (e.g., a target customer set) and/or a schedule for the selected promotion. As shown in FIG. 13, the user has selected three promotions: “15% off on wine and cheese platter,” “20% off on wine,” and “15% off birthday special.” The user may select input distribution information and/or scheduling information for these selected promotions (e.g., via user interface 1400 and/or 1500) by selecting “NEXT” on user input element 1340 and/or by selecting “Distribution” or “Schedule” on interface tab 1330.

Interface tabs 1330 may provide a mechanism (e.g., a tab, a button, a menu item, etc.) for a user to change the displayed user interface. For example, a user may select a “Promotions” tab to display user interface 1300, may select a “Distribution” tab to display user interface 1400, may select a “Schedule” tab to display user interface 1500, and may select a “Reports” tab to display user interface 1800.

User input element 1340 may provide a mechanism (e.g., a button, a menu item, etc.) for a user to change the displayed user interface. For example, user input element 1340 may provide a mechanism (e.g., a “CANCEL” button) for a user to cancel promotion activation, which may, for example, cause user interface 600 to be displayed. Additionally, or alternatively, user input element 1340 may provide a mechanism (e.g., a “BACK” button) for a user to return to a previous user interface (e.g., user interface 600) in the promotion activation process. Additionally, or alternatively, user input element 1340 may provide a mechanism (e.g., a “NEXT” button) for a user to proceed to a next user interface in the promotion activation process (e.g., user interface 1400).

Returning to FIG. 12, process 1200 may include receiving distribution information associated with the promotion (block 1220). In some implementations, promotion manager 410 may receive user input (e.g., via a button, a check box, etc.) that identifies distribution information associated with a promotion. Distribution information may include, for example, information identifying a set of target customers and/or contact information for a set of target customers (e.g., customers that a merchant wants to receive a promotion). For example, promotion manager 410 may receive distribution information via a user interface, such as user interface 1400 of FIG. 14.

FIG. 14 is a diagram of an example user interface 1400 for inputting distribution information for a promotion. In some implementations, user interface 1400 may be displayed by merchant device 210. As illustrated, user interface 1400 may include a distribution list identifier 1410, a distribution list selector 1420, a distribution list viewer 1430, a distribution list option 1440, a distribution list summary 1450, interface tabs 1330, and user input element 1340. In some implementations, user interface 1400 may include less information, additional information, different information, or differently arranged information than illustrated in FIG. 14.

In some implementations, user interface 1400 may be displayed based on user selection of a “NEXT” button on user interface 1300. For example, a user may select a promotion via user interface 1300, and may select a distribution list to associated with the selected promotion via user interface 1400.

Distribution list identifier 1410 may display an identifier (e.g., a name, a classification criteria, a characteristic, etc.) associated with a distribution list. Additionally, or alternatively, distribution list identifier 1410 may display an indication of a quantity of customers included in a distribution list. A distribution list may include information identifying a set of customers and/or customer contact information (e.g., a phone number, an address, an e-mail address, etc.). In some implementations, promotion manager 410 may store a distribution list.

In some implementations, a distribution list may be created by a merchant. Additionally, or alternatively, a distribution list may be created automatically based on point of sale information. For example, a customer may user a credit card to purchase a product and/or service associated with a promotion, and the customer may be added to a distribution list based on information associated with the credit card used to make the purchase (e.g., a name associated with the credit card, contact information associated with the credit card, etc.).

A distribution list may include customers classified based on classification criteria. For example, customers may be classified into a set of all customers, a set of customers associated with a merchant loyalty program (e.g., a subscription program, a discount program, a rewards program, etc.), a set of customers associated with one or more demographic criteria (e.g., an age bracket, a gender, an income level, a national origin, etc.), a set of customers having a birthday that falls within a particular date range and/or on a particular date, a set of customers who have purchased a particular product and/or service (e.g., take-out service, in-store purchase, etc.), etc.

In some implementations, customers may be classified into a set of customers with an address located within a certain radius of a geographic location of a merchant (e.g., a store location) and/or a set of customers associated with customer device 220 having a GPS location within a certain radius of a geographic location of a merchant. For example, a user may specify a location parameter (e.g., a distance from a merchant store, a geographic region, a city, a state, a zip code, etc.). For example, a distribution list may be created that includes customers having a physical address (e.g., a home address, a business address, etc.) within a user-specified distance from the merchant store. Additionally, or alternatively, a promotion may automatically be sent to customer device 220 located within a user-specified distance from the merchant store.

In some implementations, a customer may be classified and included in a distribution list based on point of sale information. For example, a customer location may be determined based on an address associated with a credit card that a customer uses to purchase a product and/or service associated with a promotion (and/or a non-promotional product and/or service offered by a merchant). Additionally, or alternatively, a type of product and/or service purchased by a customer (e.g., dine-in service, take-out service, in-store purchase, on-line purchase, etc.) may be determined using point of sale information.

Distribution list selector 1420 may include a mechanism (e.g., a button, a checkbox, a link, etc.) for a user to indicate a desire to send a selected promotion to customers included in a selected distribution list. For example, a user may select one or more distribution lists, and may provide user input (e.g., via a button) that causes a selected promotion to be sent to the customers included in the selected distribution list. Additionally, or alternatively, a promotion may be scheduled for delivery to customer device 220, associated with a customer included in the selected distribution list, on a user-specified date.

Distribution list viewer 1430 may provide a mechanism (e.g., a button, an icon, a link, etc.) for a user to indicate a desire to view information identifying customers and/or customer contact information included in a distribution list. For example, a user may click on distribution list viewer 1430 associated with a distribution list, and a user interface may be provided that displays information identifying customers and/or customer contact information included in the distribution list. In some implementations, a distribution list viewer 1430 may permit a user to add, delete, and/or edit the information identifying customers and/or customer contact information included in the distribution list.

Distribution list option 1440 may provide a mechanism (e.g., a checkbox, a button, etc.) for a user to select an option associated with distribution of a promotion. For example, a user may select an option to remove duplicate customers. Removing duplicate customers may cause customers included in more than one selected distribution list to receive the promotion once, rather than receiving the promotion more than once.

Distribution list summary 1450 may display an indication of a promotion that will be provided to customers on the selected distribution list. Additionally, or alternatively, distribution list summary 1450 may display a quantity of customers that will receive the promotion.

User input element 1340 may provide a mechanism (e.g., a button, a menu item, etc.) for a user to change the displayed user interface. For example, user input element 1340 may provide a mechanism (e.g., a “CANCEL” button) for a user to cancel promotion activation, which may, for example, cause user interface 600 to be displayed. Additionally, or alternatively, user input element 1340 may provide a mechanism (e.g., a “BACK” button) for a user to return to a previous user interface (e.g., user interface 1300) in the promotion activation process. Additionally, or alternatively, user input element 1340 may provide a mechanism (e.g., a “NEXT” button) for a user to proceed to a next user interface in the promotion activation process (e.g., user interface 1500).

Returning to FIG. 12, process 1200 may include receiving scheduling information associated with the promotion (block 1230). In some implementations, promotion manager 410 may receive user input (e.g., via a button, a check box, etc.) that identifies scheduling information associated with a promotion. In some implementations, the scheduling information may identify a time period during which the promotion is active. Additionally, or alternatively, the scheduling information may identify a time period during which the promotion will be sent to customers and/or customer devices. Promotion manager 410 may receive scheduling information via a user interface, such as user interface 1500 of FIG. 15.

FIG. 15 is a diagram of an example user interface 1500 for scheduling a promotion for activation. In some implementations, user interface 1500 may be displayed by merchant device 210. As illustrated, user interface 1500 may include a promotion selection element 1510, a promotion scheduling element 1520, interface tabs 1330, and a user input element 1530. In some implementations, user interface 1500 may include less information, additional information, different information, or differently arranged information than illustrated in FIG. 15.

In some implementations, user interface 1500 may be displayed based on user selection of a “NEXT” button on user interface 1400. For example, a user may select a promotion via user interface 1300, may select a distribution list to associated with the selected promotion via user interface 1400, and may schedule the selected promotion via user interface 1500.

Promotion selection element 1510 may display a promotion (e.g., a promotion selected via user interface 1300). In some implementations, a displayed promotion may be associated with distribution information (e.g., distribution information input via user interface 1400). Additionally, or alternatively, a displayed promotion may be associated with scheduling information. Scheduling information may include a start date and/or time associated with a promotion, an end date and/or time associated with a promotion, a duration of a promotion, multiple start times and end times associated with different dates of a promotion, etc. Additionally, or alternatively, a displayed promotion may be associated with a promotion identifier (e.g., a particular color used to identify a promotion). In some implementations, a user may activate or deactivate a promotion by selecting (e.g., clicking, tapping, etc.) the promotion via promotion selection element 1510. For example, a user may deactivate a promotion, which may cause server device 230 to not deliver (and/or to stop delivering) the promotion to customer devices 220.

Promotion scheduling element 1520 may display scheduling information associated with a selected promotion. In some implementations, promotion scheduling element 1520 may display a calendar, and may use a promotion identifier to indicate a date and/or time associated with a promotion. Additionally, or alternatively, a user may select (e.g., via a checkbox, a button, etc.) a promotion via promotion selection element 1510, and the promotion identifier associated with the selected promotion may be displayed on the calendar on the dates associated with the selected promotion. Additionally, or alternatively, a user may deselect (e.g., via a checkbox, a button, etc.) a promotion via promotion selection element 1510, and the promotion identifier associated with the deselected promotion may be removed from display on the calendar.

In some implementations, promotion scheduling element 1520 may provide a mechanism (e.g., a button, an icon, a textbox, etc.) for a user to input scheduling information associated with a promotion. For example, a user may select a promotion via promotion selection element 1510, and may select (e.g., by clicking or tapping on one or more dates, by clicking/tapping and dragging across multiple dates, etc.) one or more dates on which to activate the selected promotion.

User input element 1530 may provide a mechanism (e.g., a button, a menu item, etc.) for a user to change the displayed user interface. For example, user input element 1530 may provide a mechanism (e.g., a “CANCEL” button) for a user to cancel promotion activation, which may, for example, cause user interface 600 to be displayed. Additionally, or alternatively, user input element 1530 may provide a mechanism (e.g., a “BACK” button) for a user to return to a previous user interface (e.g., user interface 1400) in the promotion activation process. Additionally, or alternatively, user input element 1530 may provide a mechanism (e.g., an “ACTIVATE” button) for a user to activate a selected promotion (e.g., deliver it to the specified distribution list based on the specified schedule).

Returning to FIG. 12, process 1200 may include providing the promotion to a customer device based on the distribution information and the scheduling information (block 1240). In some implementations, promotion manager 410 may receive user input (e.g., via a button, a check box, etc.) that causes promotion manager 410 to send a promotion to customer device 220.

In some implementations, the promotion may be sent to customer device 220 based on a distribution list associated with the promotion. For example, the promotion may be sent to a customer's mobile device (e.g., via SMS text and/or MMS text) using a phone number included in a distribution list associated with the promotion. Additionally, or alternatively, the promotion may be sent to an e-mail address associated with a customer included in a distribution list associated with the promotion. Additionally, or alternatively, the promotion may be sent to customer device 220 on a particular date and/or at a particular time based on scheduling information associated with the promotion. Additionally, or alternatively, the promotion may be sent to customer device 220 based on customer device 220 entering a particular geographic area specified by a merchant (e.g., a mobile device entering a location within a merchant-specified radius of a merchant store).

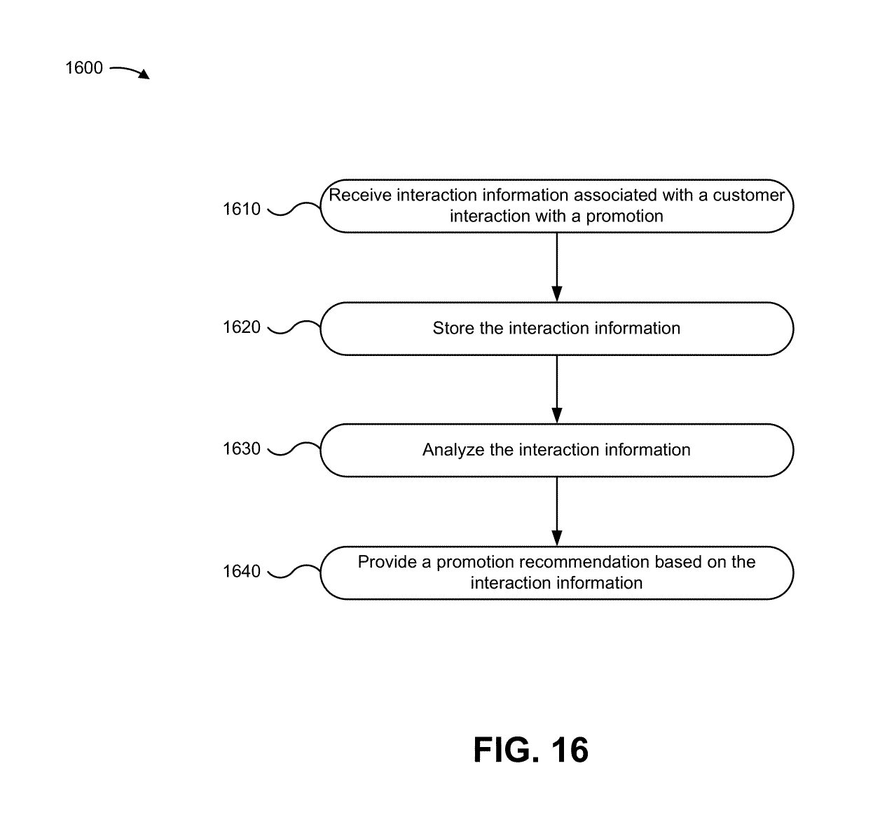

FIG. 16 is a diagram of an example process 1600 for providing a recommendation associated with a promotion. In some implementations, one or more process blocks of FIG. 16 may be performed by one or more components of merchant device 210 and/or server device 230.

As shown in FIG. 16, process 1600 may include receiving interaction information associated with a customer interaction with a promotion (block 1610). A customer interaction may include a customer purchase of a product and/or a service associated with a promotion, a customer sharing (e.g., forwarding or sending the promotion via e-mail, via text message, via social media, etc.) of a promotion, a customer social media interaction (e.g., posting the promotion to a social media site, mentioning the promotion on a social media site, commenting on the promotion on a social media site, providing a positive indication (e.g., “liking”) of the promotion on a social media site, etc.) associated with a promotion, and/or another interaction of a customer with the promotion.

Promotion manager 410 may receive interaction information based on the customer interaction. Interaction information may include, for example, a customer identifier (e.g., a name or other identification information) associated with a customer, contact information (e.g., a telephone number, a physical address, an e-mail address) associated with a customer, an indication of whether a customer has purchased a product and/or service associated with a promotion, an indication of whether a customer has shared and/or forwarded (e.g., via text message, via e-mail, via social media, etc.) a promotion, an indication of whether a customer has performed a social media interaction (e.g., a post, a comment, a mention, a like, etc.) associated with a promotion, a demographic criteria associated with a customer, a type of device (e.g., a tablet, a mobile device, etc.) that a customer uses to perform an action (e.g., a purchase, a forward, a social media interaction) associated with a promotion, whether a customer is associated with a loyalty program of a merchant associated with a promotion, a quantity of loyalty program points associated with a customer, and/or other information associated with a customer and/or a customer interaction with a promotion.

As still further shown in FIG. 16, process 1600 may include storing the interaction information (block 1620). For example, promotion manager 410 may store the interaction information (e.g., in a memory, in a data structure, in a database, in a table, etc.). Additionally, or alternatively, promotion manager 410 may associate the stored interaction information with a promotion with which the interaction information relates.

As still further shown in FIG. 16, process 1600 may include analyzing the interaction information (block 1630). In some implementations, promotion recommender 420 may aggregate interaction information associated with one or more customers, one or more merchants (e.g., merchants of the same company, merchants of different companies, etc.), and/or one or more promotions. Promotion recommender 420 may analyze the aggregated information to generate one or more key performance indicators (“KPIs”) associated with a promotion.

The KPI may include a quantity of customer purchases associated with a promotion, a quantity of customer shares and/or forwards associated with a promotion, and/or a quantity of social media interactions associated with a promotion. Additionally, or alternatively, the KPI may include a quantity of customer purchases, associated with a promotion, during a particular time period (e.g., a quantity of purchases per hour, a quantity of purchases per day, an average quantity of purchases per hour, an average quantity of purchases per day, etc.). Additionally, or alternatively, the KPI may include a quantity of customer shares and/or forwards, associated with a promotion, during a particular time period. Additionally, or alternatively, the KPI may include a quantity of social media interactions, associated with a promotion, during a particular time period.

Additionally, or alternatively, the KPI may include an amount of revenue and/or profit associated with a promotion (e.g., an amount of revenue generated due to customer purchases of a product and/or service associated with the promotion), an average amount of revenue and/or profit, associated with a promotion, during a particular time period (e.g., an average amount of revenue per hour, per day, etc.), an amount of revenue and/or profit per promotion (e.g., per purchased product and/or service associated with the promotion, per sent promotion). Additionally, or alternatively, the KPI may include a response rate associated with a promotion (e.g., a percentage or fraction of customers that purchased a product and/or service associated with the promotion, forwarded the promotion, shared the promotion, interacted with the promotion via social media, etc.).

Additionally, or alternatively, the KPI may include a cost of a promotion (e.g., a total cost, a total dollar amount spent on the promotion, a cost per promotion sent, a cost per time period, a cost per purchase, a cost per share, a cost per forward, a cost per social media interaction, etc.). Additionally, or alternatively, the KPI may include a return on investment associated with a promotion. Additionally, or alternatively, the KPI may include a quantity of new customers that performed a particular action (e.g., purchased, shared, forwarded, interacted, etc.) associated with a promotion. Additionally, or alternatively, the KPI may include a quantity of existing customers that performed a particular action (e.g., purchased, shared, forwarded, interacted, etc.) associated with a promotion. Additionally, or alternatively, the KPI may be standardized and/or normalized by determining the KPI per time period (e.g., per day, per hour, etc.), per promotion (e.g., per promotion sent), and/or per cost (e.g., per dollar spent).

Promotion recommender 420 may associate a KPI with an attribute of a promotion. For example, a KPI may be associated with a date on which a promotion was delivered and/or offered to a customer, a date on which a product and/or service associated with the promotion was purchased by a customer, a day (e.g., a day of the week) on which a promotion was delivered, offered, and/or bought, a time at which a promotion was delivered, offered, and/or bought, etc. Additionally, or alternatively, a KPI may be associated with a distribution list and/or a classification criteria (e.g., a demographic, a type of customer (e.g., new, existing, loyalty, etc.), a customer location, etc.). Additionally, or alternatively, a KPI may be associated with a template, a design item, and/or a design item layout used to create a promotion. Additionally, or alternatively, a KPI may be associated with a type of promotion (e.g., a service promotion, a product promotion, a discount, a buy-one-get-one-free offer, a coupon, a reward, an add-on product and/or service, etc.).

Returning to FIG. 16, process 1600 may include providing a promotion recommendation based on the interaction information (block 1640). In some implementations, promotion recommender 420 may recommend a promotion design (e.g., a promotion template, a promotion design item, a promotion layout, etc.), a promotion characteristic (e.g., a discount, a price, a name, a quantity of offers/inventory, etc.), a promotion distribution list (e.g., loyalty customers, new customers, existing customers, customers associated with a particular good and/or service, customers associated with a particular demographic, customers in a particular geographic region, etc.), a promotion schedule (e.g., a date and/or time to deliver a promotion, a duration of a promotion, etc.), and/or a promotion type (e.g., a product promotion, a service promotion, a discount, etc.). In some implementations, the promotion recommendation may recommend a change to a user-specified promotion. Promotion recommender 420 may provide the promotion recommendation to merchant device 210.

In some implementations, the promotion recommendation may be based on the key performance indicator (KPI) and/or the promotion attribute associated with the KPI. For example, a user may specify a KPI value to optimize (e.g., maximize, minimize, etc.), and promotion recommender 420 may recommend a promotion and/or a promotion attribute that optimizes the KPI value based on aggregated interaction information. For example, a user may select “response rate,” and promotion recommender 420 may recommend a day of the week, a time, and/or a date (or set of days, times, and/or dates) to deliver a promotion in order to maximize the response rate to the promotion. The recommendation may be based on aggregated interaction information that tracks promotion response rates per day of the week, per time, and/or per date.

Promotion recommender 420 may receive user input specifying multiple KPIs to optimize (and may receive user input specifying weights and/or thresholds to apply to the multiple KPIs). Additionally, or alternatively, promotion recommender 420 may recommend multiple promotion attributes to optimize a promotion (e.g., a promotion design and/or layout, a promotion distribution list, a promotion schedule, etc.). In some implementations, a user may specify a promotion attribute, and promotion recommender 420 may provide a recommendation for the specified promotion attribute. For example, a user may specify a date, and promotion recommender 420 may recommend a date on which to provide a promotion. Additionally, or alternatively, a user may specify a business goal, and promotion recommender 420 may recommend a promotion and/or a promotion attribute based on the business goal. For example, a user may input a business goal of attracting new customers, and promotion recommender 420 may provide a recommended promotion and/or promotion attribute to attract new customers.

FIG. 17 is a diagram of an example process 1700 for creating a promotion report. In some implementations, one or more process blocks of FIG. 17 may be performed by one or more components of merchant device 210 and/or server device 230.

As shown in FIG. 17, process 1700 may include receiving user input indicating a desire to view a promotion report (block 1710). In some implementations, promotion manager 410 may receive user input (e.g., via a button, a text box, a link, a menu, etc.) indicating that a user wants to view a promotion report. For example, promotion manager 410 may detect a user selection of report button 660 (FIG. 6). Additionally, or alternatively, a user may specify a promotion to be included in the promotion report, a set of customers to be included in the promotion report, a time period to include in the promotion report, etc.

As further shown in FIG. 17, process 1700 may include receiving interaction information based on the user input (block 1720). In some implementations, promotion manager 410 may receive information identifying a particular promotion, and may retrieve interaction information based on the received information. As indicated above, the interaction information may include, for example, information relating to a customer purchase, a customer registration for a loyalty program, a customer sharing and/or forwarding a promotion, a customer social media interaction with a promotion, etc.

As still further shown in FIG. 17, process 1700 may include creating and displaying the promotion report based on the interaction information (block 1730). In some implementations, promotion manager 410 may create the promotion report, and may display the promotion report, as discussed herein in connection with FIG. 18.

FIG. 18 is a diagram of an example user interface 1800 for displaying a promotion report. In some implementations, user interface 1800 may be displayed by merchant device 210. Additionally, or alternatively, user interface 1800 may be displayed based on user selection of report button 660. As illustrated, user interface 1800 may include a report selection element 1810, a report display element 1820, interface tabs 1330, and a user input element 1830. In some implementations, user interface 1800 may include less information, additional information, different information, or differently arranged information than illustrated in FIG. 18.

Report selection element 1810 may include a mechanism (e.g., a checkbox, a button, a text box, a menu item, etc.) for a user to select a promotion report to be displayed (e.g., via report display element 1820). In some implementations, a user may select one or more types of reports to be displayed in report display element 1820.

Report display element 1820 may display a report based on user selection of a report via report selection element 1810. Example reports that a user may select include a customer response report, a customer forwards report, a social media report, a financial data report, a new customers report, a key performance indicator (KPI) report, an actions per device report, and a demographics report.

The customer response report may display an indication of a quantity of customers that purchased a product and/or service associated with a promotion. For example, the customer response report may indicate that one hundred (100) customers purchased a product and/or service associated with the promotion for every one thousand (1,000) customers that were sent the promotion.

The customer forwards report may display an indication of a quantity of customers that shared the promotion (e.g., forwarded the promotion to another customer via e-mail, via SMS messaging, via MMS messaging, via social media, etc.). For example, the customer forwards report may indicate that fifty (50) customers forwarded the promotion to another customer for every one thousand (1,000) customers that were sent the promotion.

The social media report may display an indication of a quantity of customers that interacted with the promotion using social media (e.g., posted the promotion to a social media site, mentioned the promotion on a social media site, commented on the promotion on a social media site, gave a positive indication (e.g., “liked”) of the promotion on a social media site, etc.). For example, the social media report may indicate that one hundred (100) customers posted the promotion to a website (e.g., a social media website) for every one thousand (1,000) customers that were sent the promotion.

The financial data report may display an indication of financial metrics associated with the promotion. Financial metrics may include a total cost of a promotion, a cost per a set of promotions (e.g., a cost per one promotion, a cost per one thousand promotions, etc.), a cost per customer purchase of a product and/or service associated with a promotion, a cost per customer action (e.g., purchasing, forwarding, sharing, interacting using a social media application and/or web site, etc.), and/or other financial metrics associated with a promotion. For example, the financial data report may indicate that each customer action cost a user one dollar and ten cents ($1.10).

The new customers report may display an indication of a quantity and/or a percentage of new customers and/or existing customers that purchased a product and/or service associated with the promotion. For example, the new customers report may indicate that 25% of the customers that purchased a product and/or service associated with the promotion are new customers.

The key performance indicator (KPI) report may display an indication of KPIs associated with the promotion. KPIs may include a completion percentage of a promotional goal (e.g., a time for running the promotion, a revenue of the promotion, a return on investment of the promotion, a quantity of inventory units purchased based on the promotion, etc.) For example, the KPI report may indicate that a user has achieved twenty-five percent (25%) of the user's return on investment goal for a promotion.

The actions per device report may display an indication of a quantity of actions (e.g., purchases, forwards, social media interactions, etc.), associated with a promotion, that were completed using one or more types of devices (e.g., a tablet, a mobile device, a desktop computer, a laptop computer, etc.). For example, the actions per device report may indicate that one hundred (100) actions were taken by customers using a tablet device.

The demographics report may provide an indication of a quantity and/or a percentage of actions that were taken by customers associated with a particular demographic criteria (e.g., location, age group, etc.) For example, the demographic report may indicate that forty-three percent (43%) of customers were aged between twenty-five (25) and forty (40).

User input element 1830 may provide a mechanism (e.g., a button, a menu item, etc.) for a user to change the displayed user interface. For example, user input element 730 may provide a mechanism (e.g., a “BACK” button) to display a different user interface (e.g., return to user interface 600).

Implementations described herein may allow merchants to easily create, activate, manage, and analyze a promotion. Furthermore, implementations described herein may provide recommendations associated with a promotion in order to help a merchant attract customers and/or achieve business goals.

The foregoing disclosure provides illustration and description, but is not intended to be exhaustive or to limit the embodiments to the precise form disclosed. Modifications and variations are possible in light of the above disclosure or may be acquired from practice of the embodiments.

While series of blocks have been described with regard to FIGS. 5, 12, 16, and 17, the order of the blocks may be modified in some implementations. Further, non-dependent blocks may be performed in parallel.

Certain user interfaces have been described with regard to FIGS. 6-11, 13-15, and 18. In some implementations, the user interfaces may be customizable by a device. Additionally, or alternatively, the user interfaces may be pre-configured to a standard configuration, a specific configuration based on a type of device on which the user interfaces are displayed, or a set of configurations based on capabilities and/or specifications associated with a device on which the user interfaces are displayed. In some implementations, the user interfaces may be displayed by merchant device 210. Additionally, or alternatively, the user interfaces may be provided by server device 230 (e.g., as web pages).

As used herein, the term “component” is intended to be broadly construed as hardware, firmware, or a combination of hardware and software.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive information that identifies a design item associated with a promotion, the design item relating to an appearance of the promotion;
receive information that identifies a promotion characteristic associated with the promotion, the promotion characteristic identifying at least one of a product or a service associated with the promotion;
receive distribution information associated with the promotion, the distribution information identifying a customer device to which the promotion is to be sent;
receive scheduling information associated with the promotion, the scheduling information identifying a time period during which the promotion is active; and
provide the promotion to the customer device based on the design item, the promotion characteristic, the distribution information, and the scheduling information.

2. The device of claim 1, where the information that identifies the promotion characteristic further comprises at least one of:
an indication of whether the promotion can be shared using the customer device;
an indication of whether the at least one of the product or the service can be purchased using the customer device; or
an indication of a quantity of the at least one of the product or the service that is available for purchase.

3. The device of claim 1, where the distribution information further comprises an indication of a distance from a merchant location; and
where, when providing the promotion to the customer device, the one or more processors are further to:
provide the promotion to the customer device based on a determination that the customer device is located within the distance from the merchant location.

4. The device of claim 1, where the one or more processors are further to:
receive interaction information associated with a customer interaction with the promotion; and
provide a recommendation associated with the promotion based on the interaction information.

5. The device of claim 4, where the customer interaction comprises at least one of:
a purchase of the at least one of the product or service associated with the promotion;
a forwarding of the promotion to another customer device; or
a social media interaction associated with the promotion.

6. The device of claim 4, where, when providing the recommendation, the one or more processors are further to:
provide the recommendation based on a plurality of customer interactions with a plurality of promotions associated with a plurality of merchants.

7. The device of claim 4, where, when providing the recommendation, the one or more processors are further to:
provide a recommended change to the promotion, where the recommended change includes at least one of:
a change to the design item,
a change to the promotion characteristic,
a change to the distribution information, or
a change to the scheduling information.

8. A computer-readable medium, comprising:
one or more instructions that, when executed by one or more processors, cause the one or more processors to:
receive information that identifies a template associated with a promotion;
receive information that identifies a design item associated with a promotion, the design item relating to an appearance of the promotion;
receive information that identifies a promotion characteristic associated with the promotion, the promotion characteristic identifying a product or a service associated with the promotion;
receive distribution information associated with the promotion, the distribution information identifying a customer device associated with the promotion;
receive scheduling information associated with the promotion, the scheduling information identifying a time period during which the promotion is to be provided to the customer device; and
provide the promotion to the customer device based on the template, the design item, the promotion characteristic, the distribution information, and the scheduling information.

9. The computer-readable medium of claim 8, where the information that identifies the promotion characteristic further comprises at least one of:
an indication of whether the promotion can be shared using the customer device;
an indication of whether the at least one of the product or the service can be purchased using the customer device; or
an indication of a quantity of the at least one of the product or the service that is available for purchase.

10. The computer-readable medium of claim 8, where the distribution information further comprises an indication of a distance from a merchant location; and
where the one or more instructions that, when executed by the one or more processors, cause the one or more processors to provide the promotion to the customer device, further cause the one or more processors to:
provide the promotion to the customer device based on a determination that the customer device is located within the distance from the merchant location.

11. The computer-readable medium of claim 8, further comprising:
one or more instructions that, when executed by the one or more processors, cause the one or more processors to:
receive interaction information associated with a customer interaction with the promotion; and
provide a recommendation associated with the promotion based on the interaction information.

12. The computer-readable medium of claim 11, where the customer interaction comprises at least one of:
a purchase of the at least one of the product or service associated with the promotion;
a forwarding of the promotion to another customer device; or
a social media interaction associated with the promotion.

13. The computer-readable medium of claim 11, where the one or more instructions that, when executed by the one or more processors, cause the one or more processors to provide the recommendation, further cause the one or more processors to:
provide the recommendation based on a plurality of customer interactions with a plurality of promotions associated with a plurality of merchants.

14. The computer-readable medium of claim 11, where the one or more instructions that, when executed by the one or more processors, cause the one or more processors to provide the recommendation, further cause the one or more processors to:
provide a recommended change to the promotion, where the recommended change includes at least one of:
a change to the design item,
a change to the promotion characteristic,
a change to the distribution information, or
a change to the scheduling information.

15. A method, comprising:
receiving, by a device, a promotion;
providing, by the device, the promotion to a plurality of customer devices;
collecting information from one or more customer devices, of the plurality of customer devices, the collected information relating to at least one of:
a quantity of purchases of a product or service associated with the promotion,
a quantity of customers that shared the promotion, or
a quantity of interactions associated with the promotion;
generating, by the device, a report based on the collected information; and
providing, by the device, the report.

16. The method of claim 15, where the quantity of customers that shared the promotion comprises a quantity of customers that forwarded the promotion via text message.

17. The method of claim 15, where the interactions include at least one of:
posting the promotion to a social media web site,
mentioning the promotion on a social media web site,
commenting on the promotion on a social media web site, or
providing a positive indication of the promotion on a social media web site.

18. The method of claim 15, where the quantity of purchases comprises a quantity of new customers that purchased a product or service associated with the promotion, and the report provides an indication of the quantity of new customers that purchased the product or service associated with the promotion.

19. The method of claim 15, where the quantity of purchases comprises a quantity of customers, associated with a loyalty program of a merchant associated with the promotion, that purchased a product or service associated with the promotion, and the report provides an indication of the quantity of the customers that purchased the product or service associated with the promotion

20. The method of claim 15, where the quantity of interactions comprises a quantity of customers that interacted with the promotion using a particular type of device, and the report provides an indication of the quantity of customers that interacted with the promotion using the particular type of device.
